(19) United States
(12) Patent Application Publication
(10) Pub. No.: US 2009/0055891 A1
(43) Pub. Date: Feb. 26, 2009

(54) DEVICE, METHOD, AND PROGRAM FOR RELAYING DATA COMMUNICATION

(75) Inventors: Kohsuke OKAMOTO, Sagamihara (JP); Takashi MIYAMOTO, Tokyo (JP)

Correspondence Address: IBM CORP. (AUS);C/O MUNSCH HARDT KOPF & HARR, P.C., 3800 LINCOLN PLAZA, 500 N. AKARD STREET, DALLAS, TX, 75201-6659, US

(73) Assignee: International Business Machines Corporation, Armonk, NY (US)

(21) Appl. No.: 12/168,549

(22) Filed: Jul. 7, 2008

(30) Foreign Application Priority Data
Aug. 22, 2007 (JP) 2007-215413

(51) Int. Cl. G06F 21/00

(52) U.S. Cl. 726/1

(57) ABSTRACT

A device, method and computer program product for relaying data communication between a client and a server. A proxy device for relaying data communication between a client and a server includes a receiving unit for receiving an access request directed to the server from the client, a determining unit for determining whether transfer of a response of the server to the access request to the client will take and amount of time equal to or longer than a threshold time period, a dummy message responding unit for sending, in response to a determination result indicating that the transfer of the response will take an amount of time equal to or longer than the threshold time period, a dummy response message for notifying the client that the response of the server will be sent to the client when the response becomes available for transfer, and a transferring unit for transferring, upon the response of the server becoming transferable to the client, the response to the client.

### CROSS-REFERENCE TO RELATED APPLICATIONS

The present application claims priority under 35 U.S.C. 119 to Japan patent application no. 2007-215413 filed on Aug. 22, 2007, the entire disclosure of which is incorporated herein by reference for all purposes.

### BACKGROUND OF THE INVENTION

With widespread use of information processing technologies, such as those employed in personal computers (PC), and network technologies, such as those employed in the Internet and an intranet, these technologies are increasingly employed in business. As a result, a risk of leakage of personal information and confidential information through unauthorized accesses increases. Thus, access control to such important information is desired.

A proxy firewall has been known as one of access control techniques. Data is exchanged in a unit called a packet over a TCP/IP (Transmission Control Protocol/Internet Protocol) network. The proxy firewall permits or rejects the access with reference to a header and a data section of a packet. Accordingly, the proxy firewall enables detailed access control, such as access control for each individual user and filtering based on contents, to be performed.

The access control is performed according to an access control policy predetermined for each piece of the information by an administrator of the firewall or an owner of the information. Thus, it is difficult to previously set access control policies for all pieces of information even if the proxy firewall allows detailed access control to be performed. It is also difficult for a computer to determine whether or not an access-requested document includes personal information, for example. Since information security is currently emphasized more than users' convenience, a stricter access control policy is employed. As a result, an access request, which can be exceptionally permitted through manual judgment, is rejected.

Japanese unexamined patent application no. 2004-102951 discloses allowing a proxy device to give an instruction of additional processing. Japanese unexamined patent application no. 2004-102951 discloses a technique for transferring, to an application server, a message reconstructed from a content received from a server so that the content complies with a predetermined format, causing the application server to perform additional processing, and sending data based on the processing result to a client. Japanese unexamined patent application no. 2004-102951 also discloses processing for verifying a signature attached to content, which is suitable for high-speed processing performed by a computer.

### BRIEF SUMMARY OF THE INVENTION

Various embodiments of the present invention are directed toward a device, method and computer program product for relaying data communication between a client and a server. For example, embodiments of the present invention relate to a technique for enabling a proxy device that relays data communication to perform additional processing without being concerned about a delay in transfer of a server's response to a client's access request. In one embodiment, a proxy device for relaying data communication between a client and a server comprises a receiving unit for receiving an access request directed to the server from the client. The proxy device also comprises a policy storage unit for storing a policy that defines a criterion for identifying communication data whose transfer to a destination needs to be authorized by an authorizer. The proxy device further comprises a determining unit for determining whether the transfer of the access request or a response of the server to the access request needs to be authorized by the authorizer on the basis of the policy and to further determine whether the transfer of the response of the server to the client will take an amount of time equal to or longer than a threshold time period. The proxy device additionally comprises a dummy message responding unit for sending, in response to a determination result indicating that the transfer of the response will take an amount of time equal to or longer than the threshold time period, a dummy response message for notifying the client that the response of the server will be sent to the client when the response becomes available for transfer. The proxy device also comprises a transferring unit for transferring, upon the response of the server becoming transferable to the client, the response to the client.

In another embodiment, a proxy device for relaying data communication between a client and a server comprises a receiving unit for receiving an access request directed to the server from the client. The proxy device also comprises a request storage unit for temporarily storing the received access request. The proxy device further comprises a queue for storing a request for performing transferring processing of the access request. The proxy device additional comprises a queue setting unit for setting, in response to the reception of the access request, the request for performing transferring processing of the access request in the queue. The proxy device also comprises a first transferring unit for sequentially pulling the request for performing transferring processing from the queue and transferring the access request to the server. The proxy device further comprises a determining unit for determining whether a number of requests to be transferred to the server before the transfer of the access request is equal to or greater than a predetermined value on the basis of information stored in the queue, the predetermined value indicating whether the transfer of a response of the server to the access request to the client will take an amount of time equal to or longer than a threshold time period. The proxy device additionally comprises a dummy message responding unit for sending, in response to a determination result indicating that the transfer of the response will take an amount of time equal to or longer than the threshold time period, a dummy response message for notifying the client that the response of the server will be sent to the client when the response becomes available for transfer. The proxy device also comprises a second transferring unit for transferring, upon the response of the server becoming transferable to the client, the response to the client.

Embodiments of the present invention have been described above as proxy devices for relaying data communication. However, the present invention can be considered as methods for relaying data communication executed by such proxy devices, programs for relaying data communication, and storage media for storing such programs.

### BRIEF DESCRIPTION OF THE SEVERAL VIEWS OF THE DRAWINGS

FIG. 1 is a diagram showing an example of a configuration of a system employing a method for relaying data communication according to an embodiment of the present invention.

FIG. 2 is a diagram showing an example of a hardware configuration of a proxy server 200 according to an embodiment of the present invention.

FIG. 3 is a diagram showing an example of a functional configuration of a proxy server 200a according to an embodiment of the present invention.

FIG. 4 is a diagram showing an example of a URI table according to an embodiment of the present invention.

FIG. 5 is a diagram showing an example of a list of determining programs according to an embodiment of the present invention.

FIG. 6(a) is a diagram showing an example of an access control list according to an embodiment of the present invention.

FIG. 6(b) is a diagram showing an example of a user table according to an embodiment of the present invention.

FIG. 6(c) is a diagram showing an example of a protect object policy list according to an embodiment of the present invention.

FIG. 7(a) is a diagram showing an example of an application table according to an embodiment of the present invention.

FIG. 7(b) is a diagram showing an example of an address table according to an embodiment of the present invention.

FIG. 8 is a diagram showing an example of a management table according to an embodiment of the present invention.

FIG. 9 is a diagram showing an example of a transition of a processing status in an asynchronous processing section according to an embodiment of the present invention.

FIG. 10 is a diagram showing an example of a dummy response message created by a dummy message responding unit according to an embodiment of the present invention.

FIG. 11 is a diagram showing an example of an authorization request created by an authorization processing unit according to an embodiment of the present invention.

FIG. 12 is a flowchart showing an example of a flow of access control processing according to an embodiment of the present invention.

FIG. 13 is a flowchart showing an example of a processing flow of communication data sorting processing according to an embodiment of the present invention.

FIG. 14 is a flowchart showing an example of a processing flow of transfer processing according to an embodiment of the present invention.

FIG. 15 is a flowchart showing an example of a processing flow of determination processing of a determining program according to an embodiment of the present invention.

FIG. 16 is a flowchart showing an example of a processing flow of asynchronous processing according to an embodiment of the present invention.

FIG. 17 is a flowchart showing an example of a processing flow of connection maintenance processing according to an embodiment of the present invention.

FIG. 18 is a flowchart showing a processing flow of transfer request processing according to an embodiment of the present invention.

FIG. 19 is a flowchart showing a processing flow of authorization processing according to an embodiment of the present invention.

FIG. 20 is a flowchart showing an example of a processing flow of local processing according to an embodiment of the present invention.

FIG. 21 is a flowchart showing an example of a processing flow of request transfer processing according to an embodiment of the present invention.

FIG. 22 is a diagram showing another example of a functional configuration of a proxy server according to an embodiment of the present invention.

FIG. 23(a) is a diagram showing another example of a priority determining table according to an embodiment of the present invention.

FIG. 23(b) is a diagram showing another example of an application table according to an embodiment of the present invention.

FIG. 23(c) is a diagram showing another example of a management table according to an embodiment of the present invention.

FIG. 24 is a flowchart showing another example of a processing flow of transfer processing according to an embodiment of the present invention.

FIG. 25 is a flowchart showing another example of a processing flow of transfer processing according to an embodiment of the present invention.

FIG. 26 is a diagram showing another example of a server table according to an embodiment of the present invention.

FIG. 27 is a flowchart showing another example of a processing flow of transfer processing according to an embodiment of the present invention.

### DETAILED DESCRIPTION OF THE INVENTION

The best mode for carrying out the invention will be described below with reference to the attached drawings. However, embodiments described below are illustrative only, and do not limit the present invention defined by the appended claims. In addition, not all combinations of features described in the embodiments are indispensable to solving means of the present invention. Additionally, similar elements are denoted by similar or like reference numerals throughout the description of the embodiments.

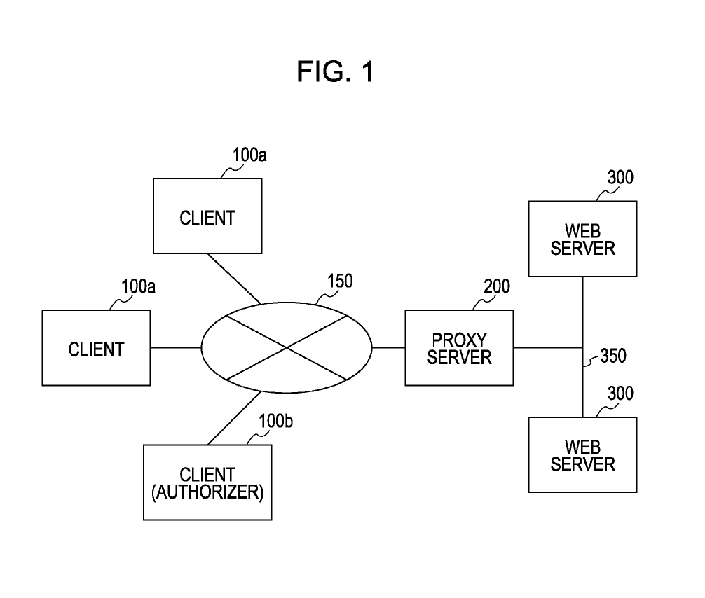

FIG. 1 is a conceptual diagram showing an example of a configuration of a system that employs a method for relaying data communication according to an embodiment of the present invention. A system according to the embodiment includes a proxy server 200 connected to the Internet 150 and an intranet 350, clients 100a and 100b connected to the Internet 150, and web servers 300 connected to the intranet 350.

In the embodiment of the present invention, the proxy server 200 receives an access request directed to the web server 300 from the client 100a via the Internet 150. The access request may be an HTTP request. Upon receiving the access request, the proxy server 200 determines whether or not transfer of a response of the web server 300 to the access request to the client 100a may be delayed or cannot be performed within a predetermined time or some threshold time period. A delay in the transfer of the response may result because, for example: 1) Transfer of an access request to the web server 300 needs to be authorized by an authorizer from the standpoint of protection of important information; 2) Transfer of a response of the web server 300 to the access request to the client 100a needs to be authorized by an authorizer from the standpoint of protection of important information; and 3) The amount of time the web server 300 takes to process the access request because a load of the web server 300 is high.

Upon determining that the transfer of the response of the web server 300 to the client 100a may be delayed or will take an amount of time equal to or greater than a threshold time period, the proxy server 200 creates a dummy response message for notifying the client 100a that the proxy server 200 will separately send the response of the web server 300 to the client 100a when the response becomes available for transfer (e.g., via a separate communication and/or communication session). The proxy server 200 then sends the dummy response message to the client 100a via the Internet 150. If the proxy server 200 determines that the transfer of the response of the web server 300 to the client 100a will take an amount of time equal to or greater than a threshold time period due to the above-given reason of 1) or 2), the proxy server 200 further requests the client 100b serving as an authorizer to perform authorization processing via the Internet 150. For example, an email may be utilized to request the authorization processing.

When a response of the web server 300 becomes available in the proxy server 200 to transfer to the client 100a (e.g., after authorization from the authorizer and the web server's 300 processing of the access request), the proxy server 200 transfers the response of the web server 300 to the client 100a via the Internet 150. In some embodiments, the proxy server 200 notifies, using an email or the like, the client 100a that the response of the web server 300 is available for transfer. In response to a transfer request sent from the client 100a, the proxy server 200 transfers the response of the web server 300 to the client 100a.

In an embodiment of the present invention, the client 100a sends an access request via the Internet 150 in order to obtain desired data from the web server 300. If the proxy server 200 determines that the transfer of the desired data to the client 100a takes an amount of time equal to or longer than a threshold time period, the client 100a receives a dummy response message from the proxy server 200. The client 100a then terminates the communication. Thereafter, the client 100a separately receives the desired data from the proxy server 200. In some embodiments, the client 100a receives a notification from the proxy server 200 notifying the client 100a that the desired data is available for transfer to the client 100a. In response to reception of the notification, the client 100a requests the proxy server 200 to transfer the desired data.

In an embodiment of the present invention, the client 100b serving as an authorizer receives an authorization request using an email or the like from the proxy server 200 via the Internet 150. Upon receiving the authorization request, the authorizer of the client 100b determines whether to not to give authorization on the basis of information on an access requester and an access target included in the authorization request. The authorizer then operates the client 100b to send the authorization result to the proxy server 200 via the Internet 150.

Those skilled in the art can appropriately realize the clients 100a and 100b using known Internet-connectable terminals. The clients 100a and 100b may be connected to the Internet 150 through an ISP (Internet Service Provider, not shown) or other method using any type of connection such as, but not limited to, a dialup connection, a dedicated line, an ADSL (Asymmetric Digital Subscriber Line), a cable modem, or other type of communication mode.

In an embodiment of the present invention, in response to an access request of the client 100a transferred from the proxy server 200, the web server 300 returns an appropriate response to the proxy server 200. A method for constructing a web server 300 is generally known. More specifically, those skilled in the art can appropriately realize the web server 300 using software, such as Microsoft Internet Information Server® provided by Microsoft Corporation or freeware called Apache.

In an embodiment of the present invention, the Internet 150 functions as a communication path that connects the clients 100a and 100b to the proxy server 200. In addition, the intranet 350 functions as a communication path that connects the web servers 300 and the proxy server 200. As those skilled in the art know, the Internet 150 and the intranet 350 connect computer systems using TCP/IP (Transmission Control Protocol/Internet Protocol). In the Internet 150 and the intranet 350, mutually-communicating computers are identified by IP addresses represented as global addresses or local addresses.

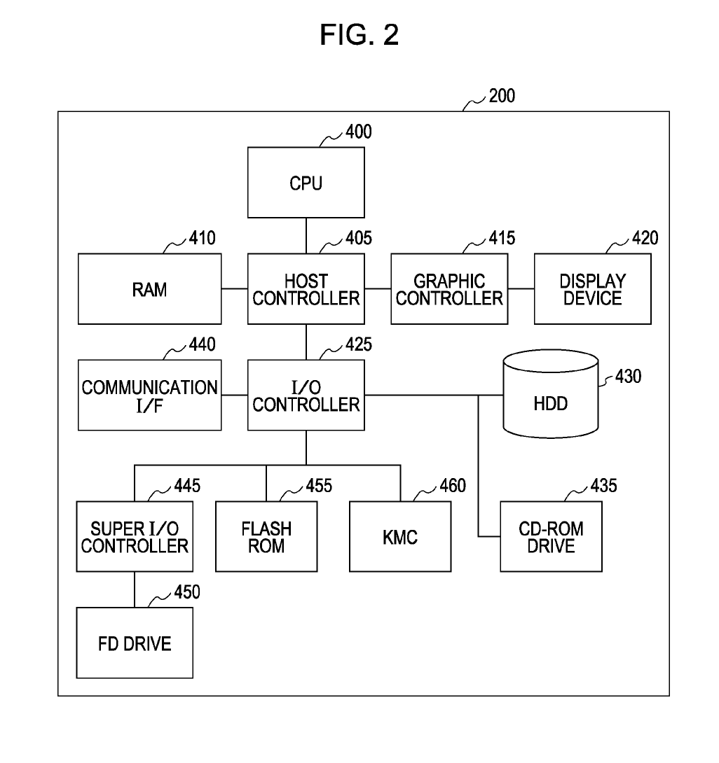

In an embodiment of the present invention, the proxy server 200 can be realized by a computer system having a hardware configuration shown in FIG. 2. The computer system includes a CPU (Central Processing Unit) peripheral section, an input/output (I/O) section, and a legacy input/output (I/O) section. The CPU peripheral section includes a CPU 400, a RAM (random access memory) 410, a graphic controller 415, and a display device 420, which are connected with each other by a host controller 405. The I/O section includes a communication interface (I/F) 440, a hard disk drive (HDD) 430, and a CD-ROM (Compact Disc-Read Only Memory) drive 435, which are connected to the host controller 405 by an input/output (I/O) controller 425. The legacy I/O section includes a super input/output (I/O) controller 445 connected to the I/O controller 425, a flexible disk (FD) drive 450, a flash ROM 455, and a keyboard/mouse controller (KMC) 460, which are connected to the super I/O controller 445.

The CPU 400 and the graphic controller 415 access the RAM 410 at a high transfer rate. The host controller 405 interconnects the RAM 410, the CPU 400, and the graphic controller 415. The CPU 400 operates on the basis of programs stored in the flash ROM 455 and the RAM 410, and controls each part. The graphic controller 415 acquires image data generated by the CPU 400 or the like in a frame buffer provided in the RAM 410, and causes the display device 420 to display images corresponding to the image data thereon. Alternatively, the graphic controller 415 may include a frame buffer for storing image data generated by the CPU 400 or the like.

The I/O controller 425 interconnects the host controller 405 and relatively high-speed I/O devices, such as the communication I/F 440, the HDD 430, and the CD-ROM drive 435. The communication I/F 440 is connected to a network through a communication adaptor (e.g., an Ethernet card or a token ring card) and communicates with other computers or the like. The HDD 430 stores programs and data used by the computer system. The CD-ROM drive 435 reads programs or data from a CD-ROM, and supplies the programs or data to the CPU 400 through the RAM 410.

The flash ROM 455 and relatively low-speed I/O devices, such as the FD drive 450 and the keyboard/mouse controller 460, are connected to the I/O controller 425. The flash ROM 455 stores a boot program executed by the CPU 400 at the time of booting of the computer system and hardware-dependent programs that are dependent on the hardware of the computer system. The FD drive 450 reads programs or data from a flexible disk and supplies the programs or data to the CPU 400 through the RAM 410. The super I/O controller 445 is connected to the FD drive 450 and various input/output devices through, for example, a parallel port, a serial port, a keyboard port, and a mouse port.

The clients 100a and 100b and the web servers 300 can be realized by a computer system having a similar hardware configuration. Various modifications, such as distribution of functions of each hardware element of the proxy server 200, the clients 100a and 100b, and the web servers 300 employed in the embodiments of the present invention to combinations of a plurality of computers, may easily occur to those skilled in the art. Such modifications should be also included in the scope and spirit of the present invention.

In some embodiments, the proxy server 200, the clients 100a and 100b, and the web servers 300 may include software, such as an operating system (OS) or middleware for allowing utilization of hardware resources. The proxy server 200 and the web servers 300 may be realized by server computers, e.g., eServer and pServer® that include an operating system AIX® provided by International Business Machines Corporation. In addition, the clients 100a and 100b may be realized by personal computers including an operating system, e.g., WindowsXP® provided by Microsoft Corporation. These operating systems have a TCP/IP communication function and can suitably provide a communication function needed in embodiments of the present invention. However, employable operating systems are not limited to these operating systems.

In addition, a program used for relaying of communication according to an embodiment of the present invention is installed in the proxy server 200 as an application program. In cooperation with the above-described hardware configuration and the software configuration, the proxy server 200 demonstrates functions described later in each embodiment. Computer programs (i.e., an operating system and application programs) are stored on a flexible disk, an optical recording medium such as a CD-ROM, a DVD, and a PD, a magneto-optical storage medium such as an MD, and a storage medium such as an IC card and a semiconductor memory, and are supplied to each computer system by a user. Alternatively, the computer programs may be supplied to each computer system by downloading the programs from a web site via a network by a user. The programs are read out from the recording medium and installed in the computer through the I/O controller 425 or are read out from another computer connected to the network and installed in the computer through the communication I/F 440. The installed programs are executed by the computer.

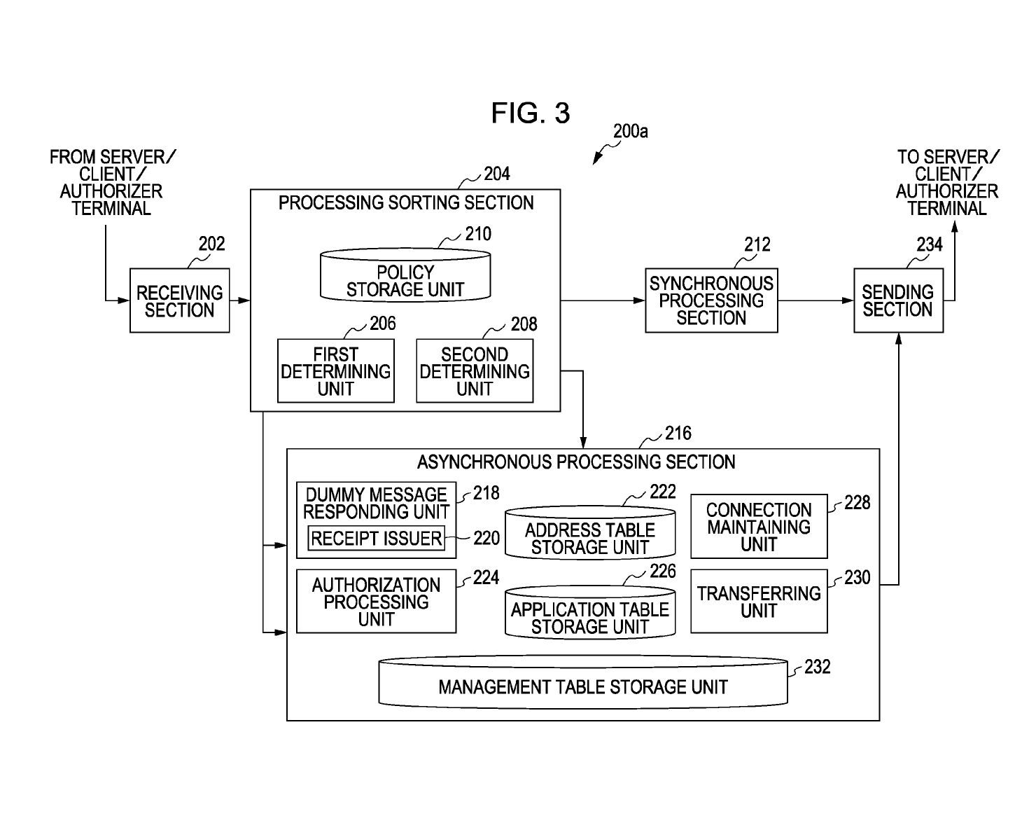

FIG. 3 shows a functional configuration of a proxy server 200a according to an embodiment of the present invention. In this embodiment, in response to, for example, a user's operation, a program used for relaying communication stored on a hard disk of an HDD 430 is loaded to a RAM 410 by an operation of an operating system. The operating system gives instructions to a CPU 400 and other peripheral devices by the program invoking predetermined API routines of the operating system, thereby allowing the proxy server 200a to function as a receiving section 202, a processing sorting section 204, a synchronous processing section 212, an asynchronous processing section 216, and a sending section 234.

The receiving section 202 receives communication data from other computer systems. The communication data received by the receiving section 202 may include an access request from a client 100a, a response transfer request also from the client 100a, a response of a web server 300 to the access request, and an authorization result report of a client 100b serving as an authorizer. The processing sorting section 204 has a function for sorting the communication data received by the receiving section 202 to one of the processing sections. The processing sorting section 204 includes a first determining unit 206, a second determining unit 208, and a policy storage unit 210. The processing sorting section 204 supplies the first determining unit 206 with the communication data received from the receiving section 202.

The first determining unit 206 determines whether or not the communication data received from the receiving section 202 requests local processing, namely, processing performed in the proxy server 200a. This determination may be performed according to whether a request URI (Uniform Resource Identifier) of an HTTP message included in a data section of the communication data indicates a specific URI associated with the proxy server 200a. If the first determining unit 206 determines that the communication data requests the local processing, the first determining unit 206 supplies the communication data to an authorization processing unit 224 or a dummy message responding unit 218 of the asynchronous processing section 216 to be described later. On the other hand, if the first determining unit 206 determines that the communication data does not request the local processing, i.e., the communication data requests transfer processing, the first determining unit 206 supplies the communication data to the second determining unit 208.

The second determining unit 208 determines whether or not transfer of a response of the web server 300 to the access request to the client 100a will be delayed or will equal or exceed a threshold time period regarding the communication data (which may be an access request from the client 100a or a response of the web server 300 to the access request) received from the first determining unit 206. In this embodiment, this determination is performed on the basis of information stored in the policy storage unit 210. The policy storage unit 210 stores a policy that defines a criterion for identifying communication data requiring authorization of an authorizer in order to transfer the communication data to a destination. The second determining unit 208 according to this embodiment determines whether or not the transfer of the response of the web server 300 to the client 100a takes an amount of time equal to or longer than the threshold time period by determining whether or not transfer of the communication data needs to be authorized by an authorizer on the basis of the policy.

The policy stored in the policy storage unit 210 may define a criterion, regarding at least one of request sender information, request receiver information, and a content of the request that are included in the access request of the client 100a, for identifying communication data whose transfer needs to be authorized by an authorizer. Here, the request sender information includes an IP address and a user ID of a sender. The request receiver information includes an IP address and a URI of a receiver. The content of the request includes a message body of an HTTP request message. Instead of or in addition to such a criterion, the policy may define a criterion, regarding at least one of response sender information, response receiver information, and a content of the response that are included in the response of the web server 300, for identifying communication data whose transfer needs to be authorized by an authorizer. Here, the response sender information includes an IP address of a sender. The response receiver information includes an IP address of a receiver. The content of the response includes all of elements of an HTTP response message including content information such as an HTML document, a server response status such as an HTTP status code, header information of an HTTP response message such as an HTTP header. In addition, the policy storage unit 210 may associate, for each request receiver that may be set in an access request of the client 100a, a policy to be applied with an authorization request receiver of communication data that is determined to require the authorization based on the policy.

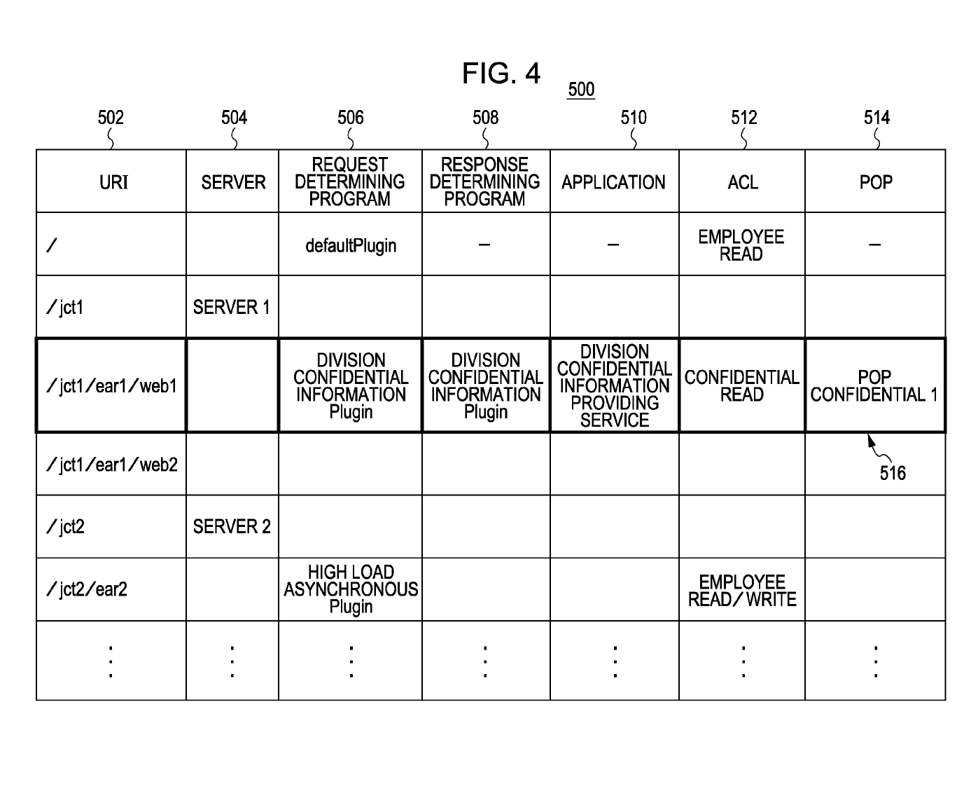

Referring to FIGS. 4 to 6(c), an example of a policy stored in the policy storage unit 210 will be described. A URI table 500 shown in FIG. 4 constitutes a part of the policy. The table 500 associates a URI 502, i.e., an access-request target that can be specified in the access request, with a policy to be applied to the access request or a response to the access request. At blank spaces in the table, setting of the upper-layer URI is inherited. A server field 504 stores a server ID of a server having an URI shown at the URI field 502. The proxy server 200a can know a web server having a URI specified in the access request with reference to the server field 504.

A request determining program field 506 stores a program ID of a program activated by the second determining unit 208 in response to the reception of the access request that specifies a URI shown at the URI field 502 as an access-request target. Similarly, a response determining program field 508 stores a program ID of a program activated by the second determining unit 208 in response to the reception of a response to the access request that specifies an URI shown at the URI field 502 as an access-request target. That is, the second determining unit 208 causes a program having a program ID stored at the request determining program field 506 or the response determining program field 508 to perform actual determination.

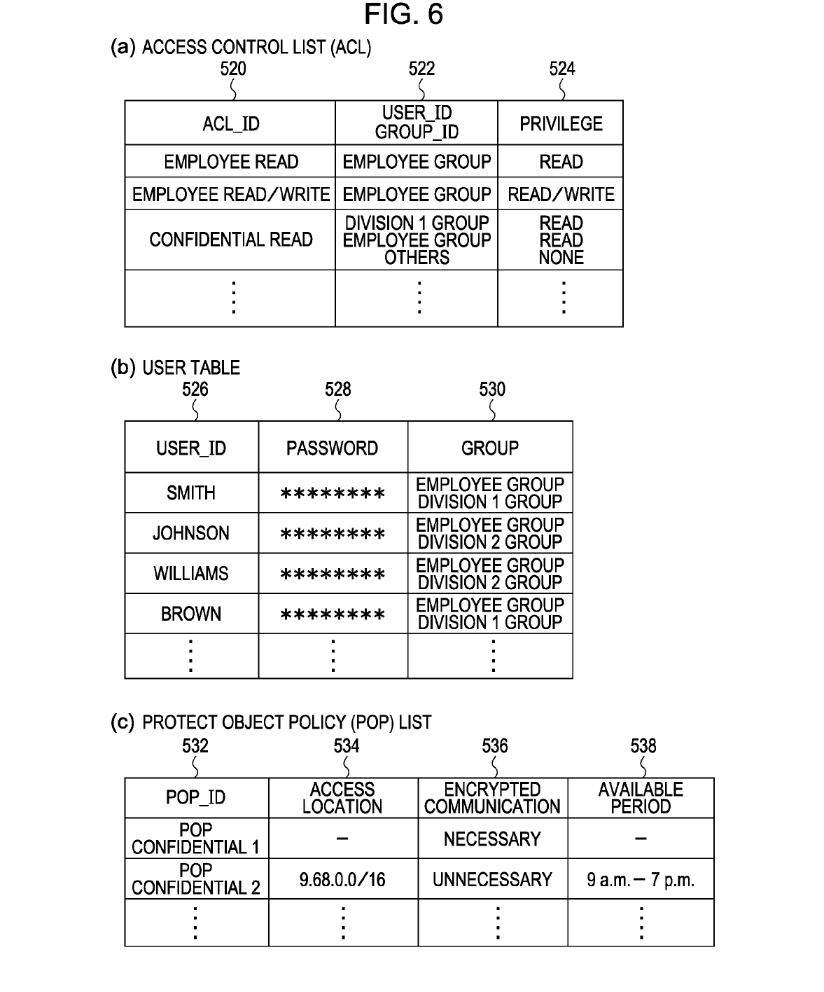

An application field 510 stores a web application ID of a web application executed in the web server 300 related to an URI shown at the URI field 502. The web application ID stored at the application field 510 is supplied to the asynchronous processing section 216 when the second determining unit 208 sorts processing of the communication data to the asynchronous processing section 216 to be described below. An access control list (hereinafter, abbreviated as ACL) field 512 stores an ID of an ACL that defines a user having an access privilege to an URI shown at the URI field 502 and a content of the privilege. FIG. 6(a) shows an example of an ACL that is a part of a policy stored in the policy storage unit 210. An ACL_ID field 520 stores an ID of an ACL. A user_ID/group_ID field 522 stores a user ID of a user having an access privilege or a group ID of a group having an access privilege. A privilege field 524 stores a content of a granted privilege, namely, read, write, or read and write.

The policy storage unit 210 further stores a user table shown in FIG. 6(b) as a part of the policy. A user_ID field 526 and a password field 528 store a user ID and a password input by a user of a client 100 on a login screen displayed on a web server 300. In addition, a group field 530 stores a group ID of a group to which a user identified by the user ID belongs.

Referring back to FIG. 4, a protect object policy (hereinafter, abbreviated as POP) field 514 stores an additional access control method to be applied to a URI shown at the URI field 502. FIG. 6(c) shows an example of a POP list constituting a part of the policy stored in the policy storage unit 210. A POP_ID field 532 stores an ID of a POP. An access location field 534 stores a location of a client 100 to be permitted access. For example, an IP address of a sender may be utilized to indicate the location. When a communication protocol, such as SSL (Secure Socket Layer) and IPSec (Security Architecture for Internet Protocol), capable of identifying a communicating entity (including a person, a device to be used, a communication device for relaying communication) is used, the communicating entity to be permitted access may be stored instead of the location. An encrypted communication field 536 stores the necessity of encryption. An available period field 538 stores a period during which access is permitted. As described above, the policy storage unit 210 according to this embodiment stores the URI table 500, the ACL, the user table, and the POP list as the policy, for example.

As described above, the second determining unit 208 according to this embodiment causes a determining program to determine whether or not transfer of communication data needs to be authorized by an authorizer on the basis of the policy. The determining program to be activated is selected by retrieving, from the URI table 500, a record having a URI matching the requested URI of the HTTP message included in a data section of the communication data. The proxy server 200a manages and processes the access request of the client 100a in association with the response of the web server 300 to the access request. More specifically, the proxy server 200a newly creates an instance every time the proxy server 200a receives a new access request from the client 100a. The created instance processes both the access request of the client 100a and the response to the access request. Accordingly, when the communication data is the response of the web server 300, the second determining unit 208 selects a determining program to be activated on the basis of the corresponding access request.

The determining program activated by the second determining unit 208 receives, as input data, the communication data received by the receiving section 202, an ACL_ID and a POP_ID stored in the respective ACL field 512 and the POP field 514 of the URI table 500. After finishing the determination, the determining program returns the determination result to the second determining unit 208. The determination result may be “asynchronous processing” for indicating that transfer of the communication data needs to be authorized by an authorizer or “synchronous processing” for indicating that permission or rejection of the access request can be immediately determined. If the determination result is “synchronous processing”, the determining program further returns a determination result of “permission” or “rejection” of the access request determined based on the ACL and the POP. If the determination result is “asynchronous processing”, the determining program further returns “authorization” for indicating that authorization is needed.

Upon receiving a determination result of “synchronous processing”, the second determining unit 208 supplies the synchronous processing section 212, to be described later, with the communication data and the determination result of “permission” or “rejection”. On the other hand, upon receiving a determination result of “asynchronous processing”, the second determining unit 208 supplies the asynchronous processing section 216, to be described later, with the communication data and the determination result of “authorization”. As described above, the proxy server 200a manages and processes the access request of the client 100a in association with the response of the web server 300 to the access request. Accordingly, when the determination result of “asynchronous processing” is obtained for the access request of one client 100a, a response of the web server 300 to this access request is treated in “asynchronous processing” even if a determination result of “synchronous processing” is obtained regarding the response. In such a case, the response is supplied to the asynchronous processing section 216.

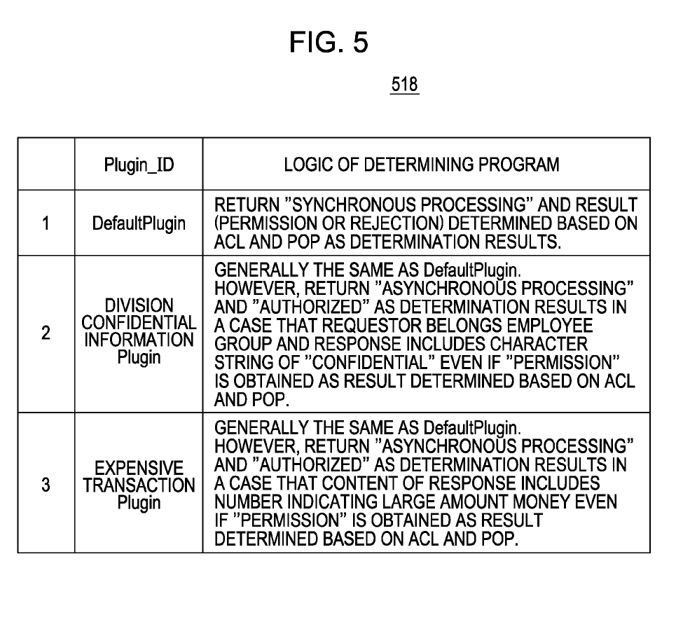

Referring next to FIG. 5, an example of determining programs that can be registered at the request determining program field 506 and the response determining program field 508 will be described. A determining program of “DefaultPlugin” listed at a field 1 of the determining program list 518 shown in FIG. 5 examines the received communication data on the basis of the corresponding ACL and POP (sometimes, the corresponding POP does not exist). The determining program returns a determination result of “synchronous processing” and a determination result of “permission” or “rejection” of the access request. Since the determining program of “DefaultPlugin” corresponds to a traditional access control technique, detailed description thereof is omitted.

A determining program of “division confidential information Plugin” listed at a field 2 of the determining program list 518 generally performs determination processing similar to that performed by the determining program of “DefaultPlugin”. However, this determining program returns determination results of “asynchronous processing” and “authorization” in a case that a requester of an access request belongs to an employee group and a response of the web server 300 to the access request includes a character string of “confidential”, even if the determination result based on the corresponding ACL and POP (sometimes, the corresponding POP does not exist) is “permission”.

The determination processing performed by the division confidential information Plugin will be described specifically for an example of a record 516 shown in FIG. 4. Here, it is assumed that communication data received by the receiving section 202 is a response from a web server 300, and an access request corresponding to the response specifies a URI of “/jct1/ear1/web1”. The second determining unit 208 retrieves the record 516 from the URI table 500 using “/jct1/ear1/web1” and “server 1” as retrieval keys. The second determining unit 208 also determines a user ID and a password from field values of an authorization request header field of a request message included in the corresponding access request. If the authorization request header field does not exist in the HTTP request message, the second determining unit 208 processes the communication data while assuming the user ID of a sender of the access request is an unauthorized user ID, for example. The second determining unit 208 activates the division confidential information Plugin on the basis of the record 516, and supplies the division confidential information Plugin with a response message included in the response of the web server 300, “confidential read”, “POP confidential 1”, and the determined user ID.

The division confidential information Plugin reads out a record having the ACL_ID set to “confidential read” from the ACL stored in the policy storage unit 210 to acquire a privilege and the content of the privilege of the sender of the access request corresponding to the response of the web server 300, namely, a user receiving the response of the web server 300. Referring to the ACL shown in FIG. 6(a), “confidential read” grants an access privilege of “read” to a division 1 group and an employee group. Accordingly, the division confidential information Plugin retrieves, from the user table (see FIG. 6(b)) stored in the policy storage unit 210, a record having the user ID and the password that match the user ID and the password received from the second determining unit 208 to determine whether or not the sender of the access request corresponding to the response of the web server 300 belongs to either the division 1 group or the employee group.

If the sender of the access request belongs to neither the division 1 group nor the employee group, the division confidential information Plugin returns “synchronous processing” and “rejection” as determination results. If the sender of the access request belongs to the division 1 group, the division confidential information Plugin reads out a record that matches “POP confidential 1” from the POP list. Referring to the POP list shown in FIG. 6(c), “POP confidential 1” requires encrypted communication. Thus, the division confidential information Plugin returns a determination result indicating necessity of encrypted communication as well as determination results of “synchronous processing” and “permission”.

On the other hand, if the sender of the access request does not belong to the division 1 group but belongs to the employee group, the division confidential information Plugin determines whether or not a body of the response message includes a character string of “confidential”. Instead of or in addition to this, the division confidential information Plugin may determine whether or not the message body includes characters, symbols, and numerals other than the character string of “confidential” for indicating important information. If the message body includes the character string of “confidential”, the division confidential information Plugin returns determination results of “asynchronous processing” and “authorization”. If the message body does not include the character string of “confidential”, the division confidential information Plugin returns determination results of “synchronous processing” and “permission”.

A determining program of “expensive transaction Plugin” listed at a field 3 of the determining program list 518 generally performs determination processing similar to that of the determining program of “DefaltPlugin”. However, the determining program of “expensive transaction Plugin” returns “asynchronous processing” and “authorization” as determination results in the case that the response of the web server 300 corresponding to the access request includes a number indicating a large amount of money, even if the determination results based on the corresponding ACL and POP (sometimes, the corresponding POP does not exist) are “synchronous processing” and “permission”. For example, whether or not the response includes a number indicating a large amount of money may be determined by detecting a case in which the response message body includes a symbol of “US$” and a number exceeding a preset threshold that follows the symbol.

The above-described division confidential information Plugin and expensive transaction Plugin are only illustrations for describing processing performed by the second determining unit 208 according to this embodiment of the present invention. It is obvious that other determining programs can be utilized as determining programs for determining whether or not transfer of communication data has to be authorized by an authorizer on the basis of a policy. For example, in the case that communication data is an access request, a determining program that returns “asynchronous processing” and “authorization” by determining whether or not a predetermined condition is met regarding at least one of a URI, a user ID, an access time, and a terminal IP address included in the access request can be utilized. Similarly, in the case that communication data is a response of the web server 300, a determining program that returns “asynchronous processing” and “authorization” by determining whether or not a predetermined condition is met regarding at least one of HTML content information included in a body of an HTTP response message, an HTTP header including time information, and an HTTP status code.

The synchronous processing section 212 processes the communication data received from the second determining unit 208 according to the determination results also received from the second determining unit 208. More specifically, upon receiving the determination result of “permission”, the synchronous processing section 212 transfers the communication data to a receiver of the communication data through the sending section 234. If the communication data is an access request from the client 100a, the receiver is the web server 300 set as an access-requested target. The synchronous processing section 212 acquires information on the web server 300 corresponding to the URI of the access-requested target from the second determining unit 208. If the communication data is a response of the web server 300 to the access request sent from the client 100a, the receiver is the client 100a that sent the access request. The synchronous processing section 212 acquires information on the sender of the access request corresponding to the response from the second determining unit 208.

On the other hand, upon receiving the determination result of “rejection”, the synchronous processing section 212 creates an error message. The synchronous processing section 212 then returns the created error message to the client 100a that sent the access request through the sending section 234. More specifically, if the determination result is “rejection”, the synchronous processing section 212 sends the error message to the client 100a that sent the access request even if the communication data is the response of the web server 300 to the access request of the client 100a.

The asynchronous processing section 216 has a function for processing communication data whose transfer is determined to require authorization of an authorizer. The asynchronous processing section 216 includes a dummy message responding unit 218, an address table storage unit 222, an authorization processing unit 224, an application table storage unit 226, a connection maintaining unit 228, a transferring unit 230, and a management table storage unit 232.

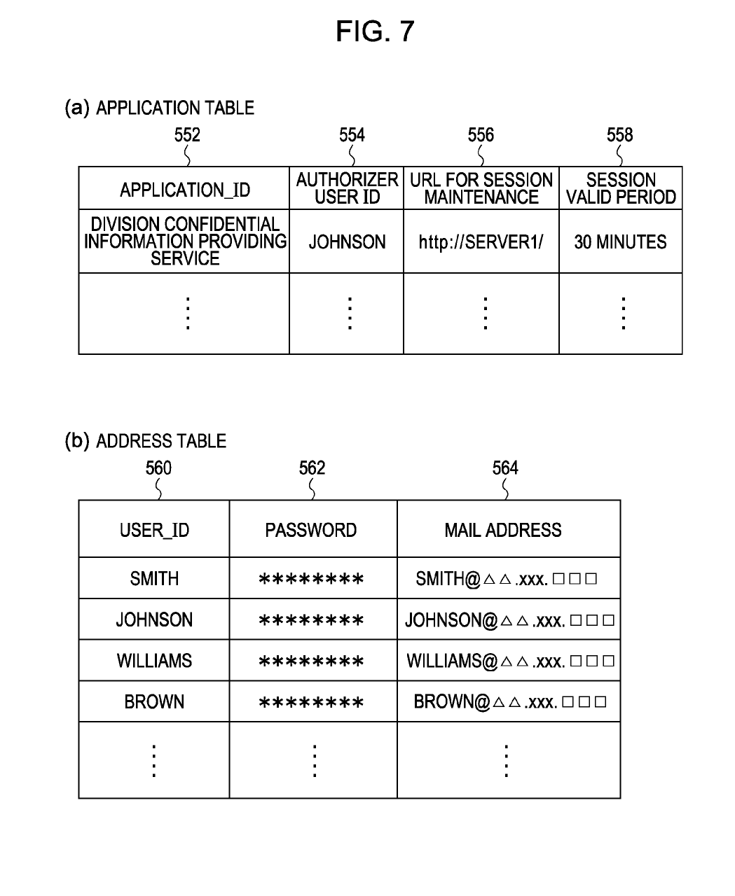

The application table storage unit 226 stores attribute information regarding web applications executed by the web server 300 to provide services to the clients 100. FIG. 7(a) shows an example of an application table. An application_ID field 552 stores an ID of a web application. This web application ID is the same web application ID stored in the application field 510 of the URI table 500 shown in FIG. 4. An authorizer user ID field 554 stores a user ID of an authorizer that authorizes a web application having the web application ID stored at the application_ID field 552 to provide information to the client 100a.

A session maintenance URL field 556 stores an URL of a transmission destination of dummy communication data that is sent to the web server 300 in order to maintain an HTTP session. Although detailed description will be given later, when the second determining unit 208 outputs a determination result of “asynchronous processing” for communication data, the client 100a receives a dummy response message instead of a response of the web server 300, thereby being able to terminate communication with the web server 300. Meanwhile, the web server 300 generally terminates an HTTP session to ensure the security and to release the resource if the client 100a logs out from the web application or if the client 100a does not log out but communication is not performed for a long time. Thus, in the case that the communication data is an access request of the client 100a, the web server 300 may terminate the HTTP session with the client 100a while the proxy server 200 is waiting for authorization for the transfer of the access request to the web server 300.

Accordingly, in this embodiment, the proxy server 200a, instead of the client 100a, sends dummy communication data to the web server 300 to allow the web server 300 to maintain the HTTP session. The HTTP session is managed not only by the main web application but also by middleware. Thus, the session maintenance URL field 556 stores a URL different from that specified when the client 100a sends the access request.

A session valid period field 558 stores a session valid period (for example, 30 minutes) that is previously set for the web application having the web application ID stored at the application_ID field 552. The proxy server 200a sends dummy communication data to the web server 300 at predetermined intervals so that this session valid period does not expire.

The address table storage unit 222 stores email addresses of users of the client 100a. FIG. 7(b) shows an example of an address table. A user_ID field 560 stores a user ID of a user of the client 100a. A password field 562 stores a password corresponding to the user ID stored at the user_ID field 560. The user ID and the password are the same as the user ID and the password stored at the user_ID field 526 and the password field 528 of the user table shown in FIG. 6(b). Although password authentication is used as an authentication method herein, an SSL client authentication and biometrics authentication may be used in the password authentication.

A mail address field 564 stores an email address of a user of the client 100a. The address table stored in the address table storage unit 222 is prepared to perform the access control according to an embodiment of the present invention. The email address is utilized when a notification document is sent to a user. Although detailed description will be given later, a user is notified of a result of authorization performed by an authorizer and, if applicable, when a response of the web server 300 becomes available, in this embodiment. The proxy server 200a may be configured to wait for a transfer request for transferring a response of the web server 300 from the user without sending such a notification document.

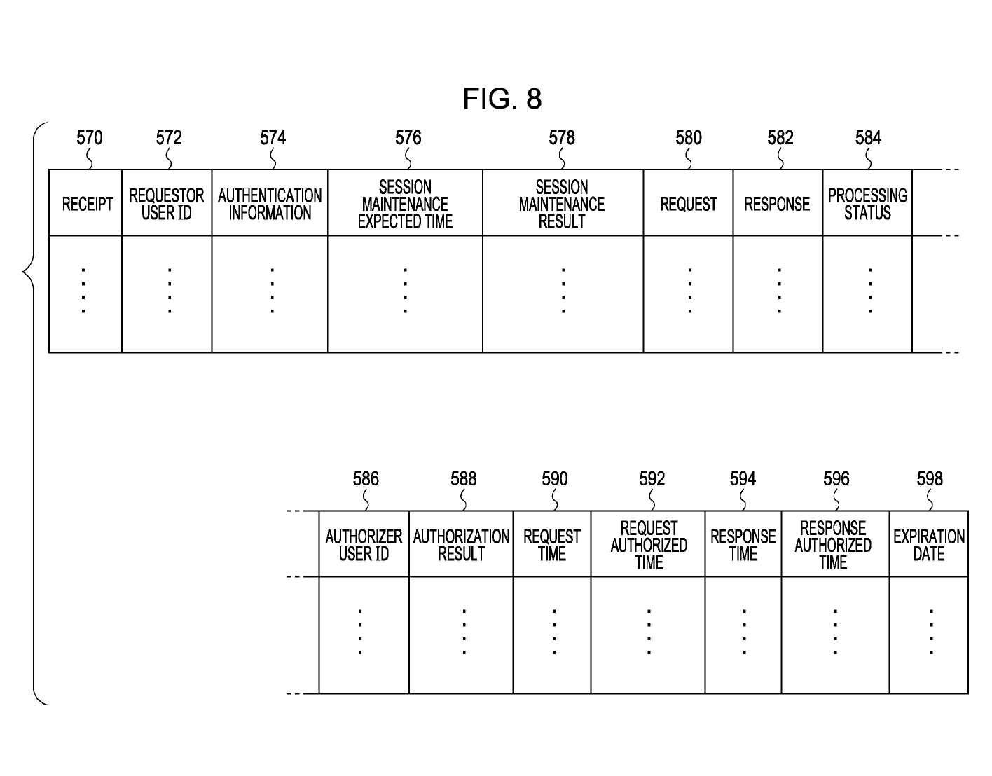

The management table storage unit 232 stores a management table used for managing processing performed on the communication data, received from the second determining unit 208, by each processing unit of the asynchronous processing section 216. FIG. 8 shows an example of a management table stored in the management table storage unit 232. Although FIG. 8 seems to show two tables, one management table actually exists.

Upon receiving the communication data from the second determining unit 208, the asynchronous processing section 216 creates a blank record in the management table for the communication data. The asynchronous processing section 216 then registers a user ID at a requester user ID field 572. When the communication data is a response of the web server 300, the asynchronous processing section 216 receives the user ID from the second determining unit 208 that manages the access request in association with the corresponding response since the user ID is included in the access request. The asynchronous processing section 216 also reads out the authorizer user ID from the matching record in the application table (see FIG. 7(a)) using the web application ID as a retrieval key, and registers the authorizer user ID at an authorizer user ID field 586 of the management table. As described above, the web application ID is supplied from the second determining unit 208 together with the communication data.

When the communication data is an access request of the client 100a, the asynchronous processing section 216 further registers the access request of the client 100a or a pointer to the access request, “request authorization wait”, and a time at which the receiving section 202 has received the communication data at a request field 580, a processing status field 584, and a request time field 590, respectively. On the other hand, when the communication data is a response of the web server 300, the asynchronous processing section 216 registers the response of the web server 300 or a pointer to the response of the web server 300, “response authorization wait”, and a time at which the receiving section 202 has received the communication data at a response field 582, the processing status field 584, and a response time field 594, respectively. However, when the asynchronous processing server 216 receives a determination result of “synchronous processing” from the second determining unit 208 together with the response of the web server 300, the asynchronous processing unit 216 registers “response reply wait” at the processing status field 584. The response time field 594 may be utilized as a criterion for removing a record from the management table. For example, when a requester does not request for the transfer of a response within a predetermined period from the reception of a response, the record may be removed.

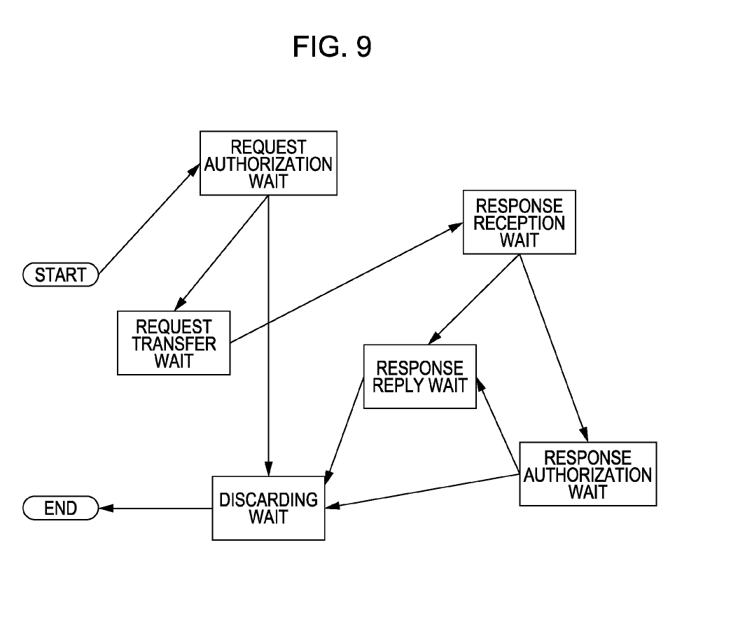

The status registered at the processing status field 584 is a processing status of the communication data in the asynchronous processing section 216. FIG. 9 shows an example of a state transition of processing of communication data. Upon receiving an access request from the second determining unit 208, the processing status of the communication data in the asynchronous processing section 216 is set to a state of “request authorization wait”. When authorization is obtained, the processing status is changed to a state of “request transfer wait”. Upon the communication data being transferred to the web server 300, the processing status is changed to a state of “response reception wait”. Thereafter, the reception of the response changes the processing state into a state of “response reply wait” or a state of “response authorization wait” and then to the state of “response reply wait”. Lastly, in response to the transfer of the response to the client 100a, the processing status is changed to a state of “discarding wait”. On the other hand, if the transfer of the access request is not authorized, the processing status is changed to the state of “discarding wait” from the state of “request authorization wait”. Similarly, when the transfer of the response is not authorized, the processing status is changed to the state of “discarding wait” from the state of “response authorization wait”.

In the case that the communication data is an access request of the client 100a, the asynchronous processing section 216 further registers authentication cookie information previously created for the client 100a by the web server 300 at an authentication information field 574. It is assumed that the authentication cookie information is extracted from the request sent from the client 100a to the web server 300 and stored beforehand. The asynchronous processing section 216 further registers, at a session maintenance expected time field 576, a time obtained by adding a session valid period to the request time registered at the request time field 590 of the management table. At this time, the session valid period is obtained by retrieving a matching record from the application table (see FIG. 7(a)) using the web application ID as a retrieval key. Other fields of the management table will be described in the description of each processing unit of the asynchronous processing section 216.

In response to a determination result of the second determining unit 208 indicating that the transfer of the communication data to the client 100a will not occur until after the expiration of some threshold time period, the dummy message responding unit 218 sends, to the client 100a, a dummy response message for notifying the client 100a that the proxy server 200a will separately send the response of the web server 300 to the client 100a. Since the client 100a receives the dummy response message as a response to the access request, the reception of the dummy response message allows the client 100a to terminate the communication with the web server 300.

The dummy message responding unit 218 includes a receipt issuer 220 for issuing a receipt that is included in the dummy response message and that indicates a valid receiver of the response of the web server 300. As described above, the reception of the dummy response message allows the client 100a to terminate the communication with the web server 300. Accordingly, when the proxy server 200a separately sends the response of the web server 300 to the client 100a, it is desirable to authenticate the client 100a again from the standpoint of security.

The proxy server 200a according to this embodiment sends, to the client 100a, a dummy response message including a receipt used in authentication. The proxy server 200a then requires the client 100a to show the receipt before the proxy server 200a transfers the response of the web server 300. Instead of or in addition to this, authentication using a user ID can also be utilized. By storing the receipt in association with the user ID in the proxy server 200a, the receipt functions as an identifier for identifying a response of the web server 300 to be transferred in a case that asynchronous processing is performed in parallel on a plurality of access requests sent from an identical user.

The receipt issued by the receipt issuer 220 may be a difficult-to-guess character string. For example, a character string obtained by converting a long enough random number string by a hush function can be utilized. In addition, a valid period may be set for the receipt. The receipt issuer 220 registers the issued receipt and the valid period of the receipt at a receipt field 570 and an expiration date field 598 of the management table, respectively.

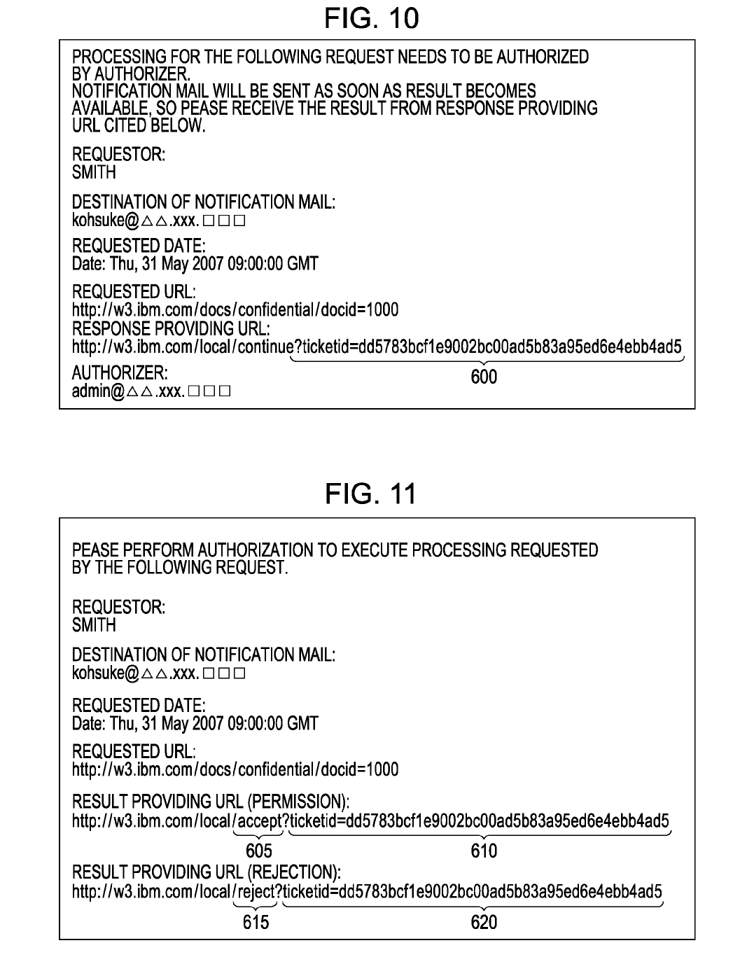

FIG. 10 shows an example of a dummy response message created as an HTML document in the case that communication data is an access request of the client 100a. The dummy response message shown in FIG. 10 includes a name of a user of the client 100a, i.e., a name of a requester, a sending destination of a notification mail for notifying the client 100a that the response of the web server 300 becomes transferable, a request date at which an access request is made, a request URL for indicating a content of the access request, a response providing URL for indicating a location at which the response of the web server 300 to the access request is provided, and an email address of an authorizer.

A user ID can be used as the name of the requester. The sending destination of the notification mail is read out from the address table (see FIG. 7(b)) using the user ID as a retrieval key. If the user ID is the unauthorized user ID, a form to which the sending destination address of the notification mail is input and an address setting button are created instead of writing the sending destination of the notification mail. A user of the client 100a who has received the dummy response message inputs an address through which the user desires to receive the notification mail in the form and clicks the address setting button, thereby being able to send an address setting request to the proxy server 200a. A value of the request time field 590 of the management table can be utilized as the request date. In addition, an email address of the authorizer can be utilized as the description about the authorizer. The email address of the authorizer is obtained by firstly reading out the authorizer ID from the authorizer user ID field 586 of the management table and then retrieving a matching record from the address table (see FIG. 7(b)) using the read out authorizer ID as a retrieval key.

In the example dummy response message shown in FIG. 10, the receipt is embedded in the response providing URL as “ticketid” (600). Accordingly, for example, the user of the client 100a simply specifies the response providing URL at an address field of a web browser to send the receipt to the proxy server 200a. Thus, the receipt may be written separately from the response providing URL and the receipt may be directly input when the client 100a accesses the proxy server 200a. In the case that the communication data is a response of the web server 300, a similar dummy response message may be created.

The authorization processing unit 224 creates an authorization request to obtain authorization of the authorizer for the transfer of the communication data received from the second determining unit 208. The authorization processing unit 224 then sends the authorization request to an authorization request receiver through the sending section 234. For example, an email can be utilized as the requesting method. Information on the authorization request receiver can be obtained by retrieving a matching record from the address table (see FIG. 7(b)) using the authorizer ID read out from the management table as a retrieval key as described above.

FIG. 11 shows an example of an authorization request created as an email. The authorization request shown in FIG. 11 includes a content of the request for indicating that an authorization target is request processing or response replying processing, a name of a requester, a sending destination of a notification mail for notifying that the response of the web server 300 becomes transferable or the access is rejected, a request date at which the access request is made, a request URL indicating a content of the access request, result providing URLs (for permission and rejection) at which authorization processing is performed. The target of the authorization request shown in FIG. 11 is the request processing. In the case that the authorization target is the response replying processing, the content of request may be set as “PLEASE PERFORM AUTHORIZATION TO EXECUTE RESPONSE REPLYING PROCESSING FOR THE FOLLOWING REQUEST.”, for example.

A user ID can be used as the requestor name. The sending destination of the notification mail is read out from the address table (see FIG. 7(b)) using the user ID as a retrieval key. A value of the request time field 590 of the management table can be utilized as the request date. The request URL can be obtained from the value of the request field 580 of the management table.

In the example authorization request shown in FIG. 11, the authorization result and the receipt are embedded in two kinds of result providing URLs as “accept” and “reject” (605 and 615) and “ticketid” (610 and 620), respectively. Accordingly, for example, the authorizer simply selects the result providing URL corresponding to the authorization result and specifies the selected URL at an address field of a web browser, thereby being able to send the authorization result of “permission” or “rejection” and the receipt to the proxy server 200a. Thus, the result providing URL excluding the authorization result and the receipt may be written in the authorization request, and the authorization result and the receipt may be directly input when the authorizer accesses the proxy server 200a.

The result of the authorization performed by the authorizer is supplied to the authorization processing unit 224 through the first determining unit 206 after being received by the receiving section 202. Upon receiving the authorization result, the authorization processing unit 224 retrieves a matching record from the management table (see FIG. 8) using the receipt included in the authorization result as a retrieval key. If the matching record exists and the value of the authorizer user ID field 586 of the record matches the user ID of the authorizer included in the authorization result, the authorization processing unit 224 further confirms that the value of the processing status field 584 of the record is set to “request authorization wait” or “response authorization wait”. The authorization processing unit 224 registers the authorization result at an authorization result field 588 of the management table. The authorization processing unit 224 sends a message indicating that the authorization result is accepted to the client 100b serving as the authorizer through the sending section 234. In other cases, the authorization processing unit 224 sends an error message indicating an inappropriate request to the client 100b serving as the authorizer through the sending section 234.

When the value of the processing status field 584 of the record is set to “request authorization wait” at the time of registration of the authorization result in the management table, the authorization processing unit 224 registers “request permitted” and “request rejected” if the authorization result is “permission” and “rejection”, respectively. Similarly, when the value of the processing status field 584 of the record is set to “response authorization wait”, the authorization processing unit 224 registers “response permitted” and “response rejected” if the authorization result is “permission” and “rejection”, respectively. At this time, the authorization processing unit 224 registers a time at which the authorization is obtained at a request authorized time field 592 or a response authorized time field 596. The authorized time fields can be utilized as a log when an authorization state is monitored.

The authorization processing unit 224 that received the determination result further updates the processing status field 584 of the management table. If the transfer of the access request is authorized, the authorization processing unit 224 changes the processing status to “request transfer wait”. Similarly, the transfer of the response of the web server 300 is authorized, the authorization processing unit 224 changes the processing status to “response reply wait”. If the transfer of the access request of the client 100a or the transfer of the response of the web server 300 is not authorized, the authorization processing unit 224 changes the processing status to “discarding wait”.

When changing the processing status to “response reply wait” or “discarding wait”, the authorization processing unit 224 also notifies the client 100a of the authorization result. For example, an email may be utilized as the notification method. The email address of the notification receiver can be obtained by retrieving a matching record from the address table (see FIG. 7(b)) using the requestor user ID read out from the management table as a retrieval key.

The connection maintaining unit 228 regularly sends dummy communication data to the web server 300 to enable the web server 300 to maintain the session with the client 100a until the transfer of the access request of the client 100a to the web server 300 is authorized by the authorizer. The sending destination of the dummy communication data is obtained by reading out a URL for session maintenance stored in a matching record from the application table (see FIG. 7(a)) using the web application ID as a retrieval key. Authentication cookie information registered at the authentication information field 574 of the management table is used so that the web server 300 considers that the dummy communication data sent to the web server 300 is perceived as being sent from the client 100a.

The connection maintaining unit 228 regularly reads out the session maintenance expected time from the session maintenance expected time field 576 of the management table until the value of the processing status field 584 of the management table is changed to “request transfer wait” from “request authorization wait”, and compares the session maintenance expected time with the current time. If the current time is before the session maintenance expected time, the connection maintenance unit 228 sends dummy communication data created using the authentication cookie information to the read out URL for session maintenance.

Upon receiving a response indicating a success from the web server 300 for the transmission of the dummy communication data, the connection maintaining unit 228 registers “success” at the session maintenance result field 578 of the management table. The connection maintaining unit 228 also reads out the session valid period of a matching record of the application table (see FIG. 7(a)) using the web application ID as a retrieval key, and updates the value of the session maintenance expected time field 576 to a value obtained by adding the session valid period to the current time.

On the other hand, upon receiving a response indicating a failure from the web server 300 for the transmission of the dummy communication data, the connection maintaining unit 228 registers “failure” at the session maintenance result field 578 of the management table. The connection maintaining unit 228 also changes the value of the session maintenance expected time field 576 of the management table to “to be determined”.

The transferring unit 230 transfers the access request to the web server 300 through the sending section 234 under the condition that the transfer of the access request to the web server 300 is authorized by the authorizer. More specifically, the transferring unit 230 checks the management table at predetermined intervals to detect a record having the value of the processing status field 584 set to “request transfer wait”. Upon detecting such a record, the transferring unit 230 confirms that the value of the session maintenance result field 578 of the management table is “success”. The transferring unit 230 then reads out the access request of the client 100a from the management table and transfers the access request to the web server 300 through the sending section 234. At that time, the transferring unit 230 changes the value of the processing status field 584 of the management table to “response reception wait”.

Upon the response of the web server 300 becoming available to transfer to the client 100a, the transferring unit 230 transfers the response of the web server 300 to the client 100a. In some embodiments, the transferring unit 230 transfers the response of the web server 300 to the client 100a in response to the transfer request sent from the client 100a that is notified of the transfer permission. For example in some embodiments, the transferring unit 230 transfers the response of the web server 300 to the client 100a under the condition that the proxy server 200a receives a receipt from the client 100a together with the transfer request from the client 100a that is notified with the transfer permission.

As described above, in this embodiment, the proxy server 200a notifies the client 100a of the result of the authorization performed by the authorizer. Accordingly, the client 100a having received a notification indicating the authorization result is “permission” inputs the response providing URL including the receipt written in the previously received dummy response message in an address field of a web browser, thereby sending, to the proxy server 200a, a transfer request for transferring a response of the web server 300.

The transfer request of the client 100a is received by the receiving section 202, and then supplied to the dummy message responding unit 218 through the first determining unit 206. The dummy message responding unit 218 having received the transfer request retrieves a matching record from the management table using the receipt extracted from the transfer request as a retrieval key. If the matching record exists and the value of the requestor user ID field 586 of the record matches the user ID of the requester included in the transfer request, the dummy message responding unit 218 further confirms that the value of the processing status field 584 of the record is set to “response reply wait” and the receipt expiration date registered at the expiration date field 598 indicates a future date. The confirmation result of the dummy message responding unit 218 is supplied to the transferring unit 230 together with the receipt.

Upon receiving a confirmation result of “failure”, the transferring unit 230 sends an error message indicating an inappropriate request to the client 100a through the sending section 234. On the other hand, upon receiving a confirmation result of “success”, the transferring unit 230 transfers the response of the web server 300, which is read out from the management table using the receipt as a retrieval key, to the client 100a through the sending section 234. Thereafter, the transferring unit 230 changes the value of the processing status field 584 of the management table to “discarding wait”.

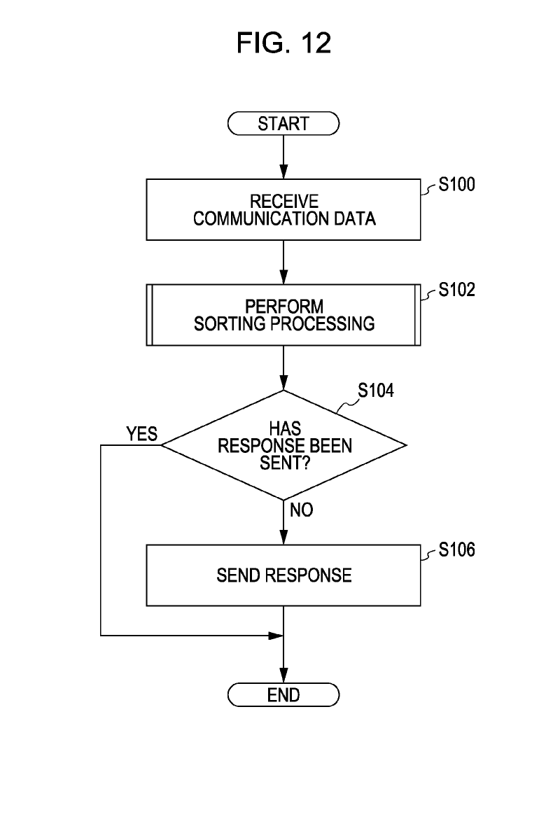

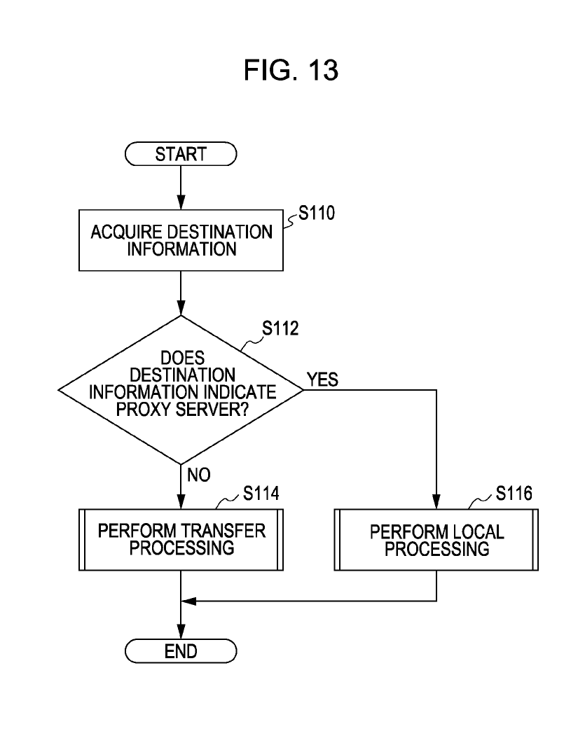

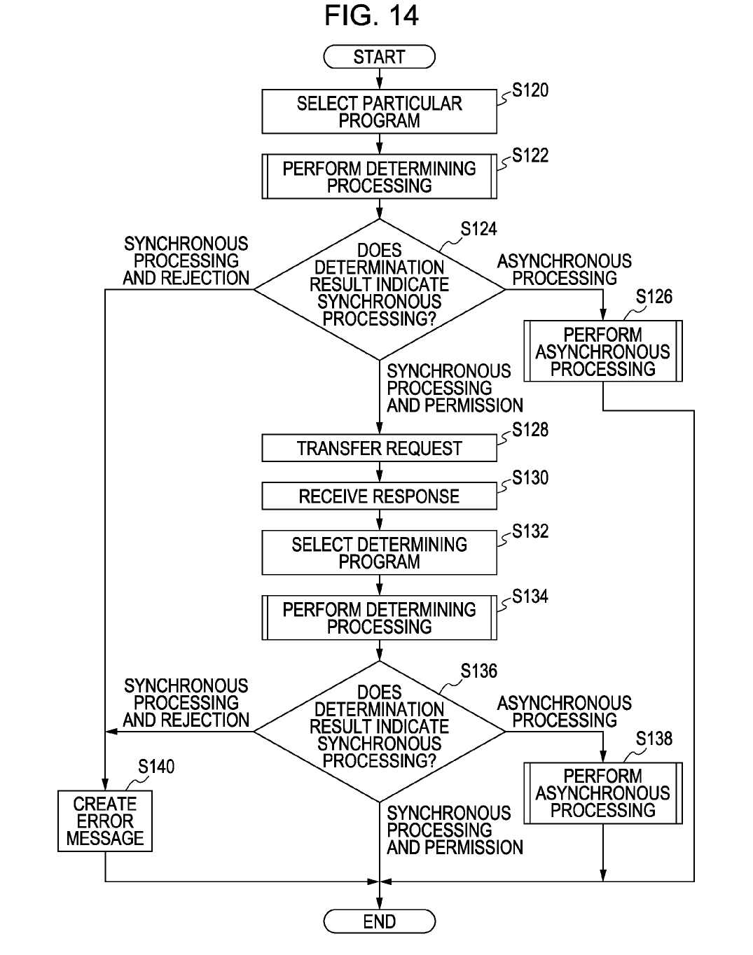

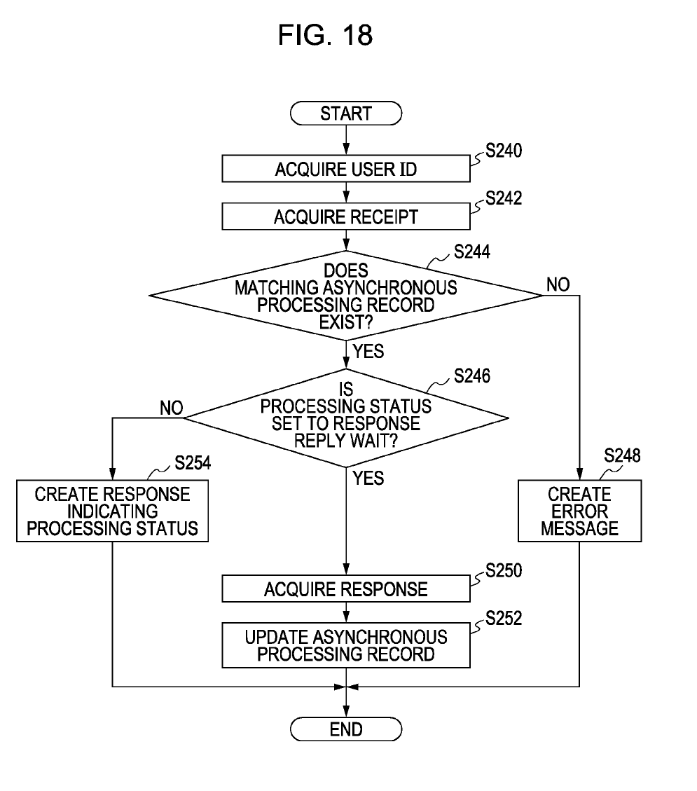

An example of a flow of processing for relaying data communication performed by the proxy server 200a according to an embodiment of the present invention will be described next with reference to flowcharts shown in FIGS. 12 to 21. The processing starts at STEP 100 of FIG. 12. Upon the proxy server 200a receiving communication data (e.g., one of an access request/a response transfer request of the client 100a and an authorization result report of the client 100b) from another information processing device, the processing sorting unit 204 sorts the communication data to an appropriate processing unit (STEP 102). The details of the processing sorting performed by the processing sorting unit 204 will be described later with reference to FIGS. 13 and 18. After the processing units finish processing the communication data, the proxy server 200a determines whether or not a response to the received communication data has been sent (STEP 104). If the response has not been sent (NO of STEP 104), the proxy server 200a sends a result of the processing performed by each processing unit to the other information processing device as a response to the received communication data (STEP 106). If the response has been sent (YES of STEP 104) or after performing the STEP 106, the proxy server 200a terminates the process.

FIG. 13 shows an example of a detailed processing flow of the sorting processing shown at STEP 102 of FIG. 12. The first determining unit 206 having received the communication data extracts the address information from the communication data (STEP 110), and determines whether or not the address information included in the communication data indicates the proxy serve 200a (STEP 112). If the address information does not indicate the proxy server 200a (NO of STEP 112), the first determining unit 206 supplies the communication data (e.g., the access request of the client 100a or the response of the web server 300) to the second determining unit 208 to cause the second determining unit 208 to perform transfer processing (STEP 114). The details of the transfer processing will be described later with reference to FIGS. 14 to 18. On the other hand, if the address information included in the communication data indicates the proxy server 200a (YES of STEP 112), the first determining unit 206 performs local processing on the communication data (e.g., the response transfer request of the client 100a or the authorization result report of the client 100b ) (STEP 116). The details of the local processing will be described with reference to FIGS. 18 to 20. Thereafter, the sorting processing is terminated.

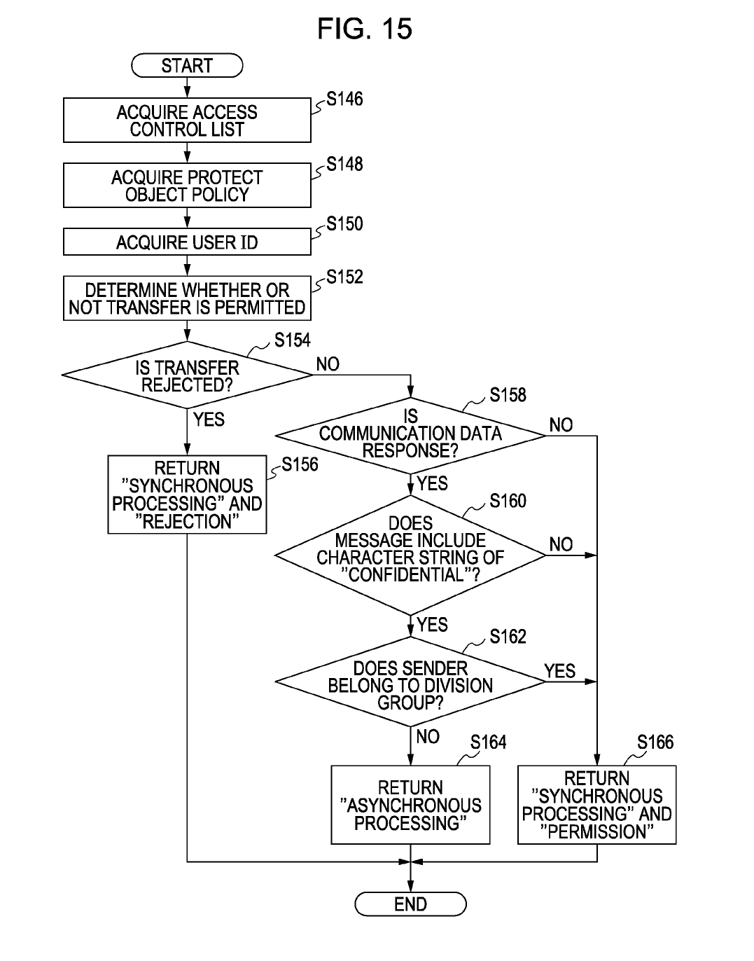

FIG. 14 shows an example of a more detailed processing flow of the transfer processing shown at STEP 114 of FIG. 13. The second determining unit 208 selects a determining program from the URI table 500 on the basis of a resource requested by the access request (STEP 120). The determining program determines whether or not the transfer of the access request from the client 100a needs to be authorized by an authorizer on the basis of the policy. The selected determining program performs the determination processing on the access request (STEP 122). FIG. 15 shows an example of a flow of determination processing performed by the division confidential information Plugin shown in the determining program list 518.

At STEPs 146, 148, and 150 of FIG. 15, the division confidential information Plugin acquires, from the second determining unit 208, an ACL and a POP to be applied to the communication data and a user ID of a sender of the communication data. The division confidential information Plugin determines whether or not the transfer of the communication is permitted on the basis of these pieces of information (STEP 152). If the division confidential information Plugin determines that the transfer of the communication data is rejected (YES of STEP 154), the division confidential information Plugin returns determination results of “synchronous processing” and “rejection” to the second determining unit 208 (STEP 156).

On the other hand, if the division confidential information Plugin determines that the transfer of the data is permitted (NO of STEP 154), the division confidential information Plugin then determines whether the communication data is a response of the web server 300 (STEP 158). This determination may be preformed by determining whether or not an HTTP message included in a data section of the communication data includes a status code, for example. If the communication data is the response of the web server 300 (YES of STEP 158), the division confidential information Plugin further determines whether or not a body of the HTTP message includes a character string indicating “confidential” (STEP 160). If the HTTP message body includes the character string indicating “confidential”, the division confidential information Plugin determines whether or not the sender belongs to a division group (STEP 162).

If the HTTP message body includes the character string indicating “confidential” (YES of STEP 160) and the sender does not belong the division group (NO of STEP 162), the division confidential information Plugin returns determination results of “asynchronous processing” and “authorization” to the second determining unit 208 (STEP 164). On the other hand, if the communication data is not the response of the web server 300 (NO of STEP 158), if the HTTP message body does not include the character string indicating “confidential” (NO of STEP 160), or if the sender belongs to the division group (YES of STEP 162), the division confidential information Plugin returns determination results of “synchronous processing” and “permission” to the second determining unit 208 (STEP 166). Thereafter, the division confidential information Plugin terminates the processing.

Referring back to FIG. 14, the second determining unit 208 determines whether or not the determination result of the determining program is “synchronous processing” (STEP 124). If the determination result indicates “synchronous processing”, the second determining unit 208 supplies the access request to the synchronous processing section 212 together with the determination result of “permission” or “rejection”. If the received determination result is “permission”, the synchronous processing section 212 transfers the access request to the web server 300 (STEP 128). The web server 300 processes the access request, and returns a response to the access request.

Upon the proxy server 200a receiving the response to the access request (STEP 130), the response is supplied to the second determining unit 208 through the processing shown in FIGS. 12 and 13 described above. The second determining unit 208 then selects a determining program for the response on the basis of the corresponding access request (STEP 132). The selected determining program performs the determination processing on the response (STEP 134). The second determining unit 208 again determines whether or not the determination result of the determining program is “synchronous processing” (STEP 136). If the determination result indicates “synchronous processing”, the second determining unit 208 supplies the access request to the synchronous processing section 212 together with the determination result of “permission” or “rejection”.

If the determination result is determined to indicate “synchronous processing” at STEP 124 or 136 and the determination result of “rejection” is received from the second determining unit 208, the synchronous processing section 212 creates an error message as a response to the access request of the client 100a (STEP 140). On the other hand, if the determination result is determined to indicate “synchronous processing” at STEP 136 and the determination result of “permission” is received from the second determining unit 208, the synchronous processing section 212 uses the response of the web server 300 as a response to the access request of the client 100a.

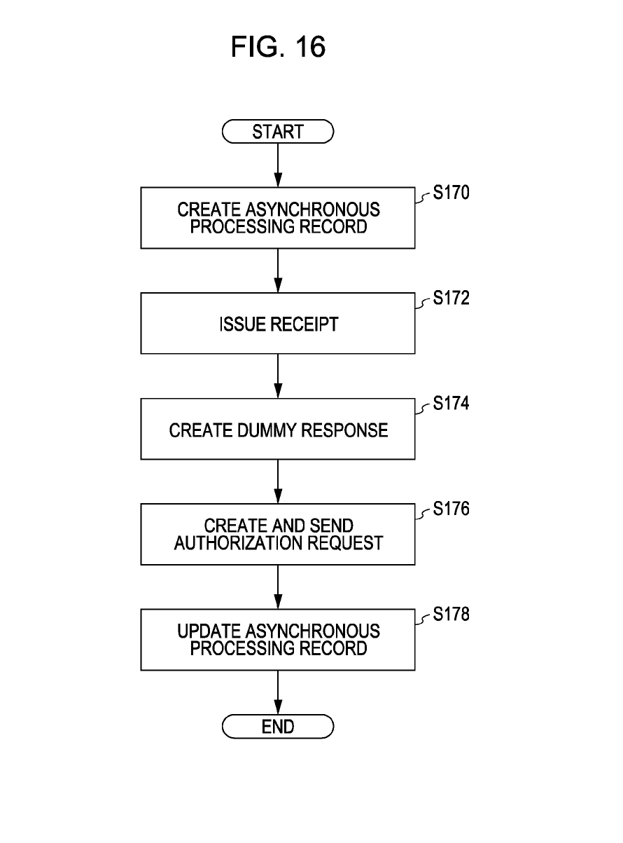

On the other hand, if the determination results indicate “asynchronous processing” and “authorization” at STEP 124 or 136, the second determining unit 208 supplies the access request of the client 100a or the response of the web server 300 to the asynchronous processing section 216. The details of the asynchronous processing performed by the asynchronous processing section 216 will be described later with reference to FIGS. 16, 17, and 19. After performing STEP 136, 138, or 140, the process is terminated.

FIG. 16 shows an example of a detailed processing flow of the asynchronous processing shown at STEPs 126 and 138 of FIG. 14. The asynchronous processing section 216 creates a record of the communication data received from the second determining unit 208 in the management table (STEP 170). The dummy message responding unit 218 of the asynchronous processing section 216 issues a receipt for the communication data (STEP 172). The dummy message responding unit 218 creates a dummy response message indicating that the proxy server 200a will separately send the response of the web server 300 to the client 100a as a response to the access request of the client 100a (STEP 174). In addition, the authorization processing unit 224 of the asynchronous processing section 216 creates an authorization request for requesting an authorizer to authorize the transfer of the access request of the client 100a or the response of the web server 300, and sends the authorization request to the client 100b serving as the authorizer (STEP 176). Lastly, the asynchronous processing section 216 updates the content of the record of the management table (STEP 178), and terminates the processing.

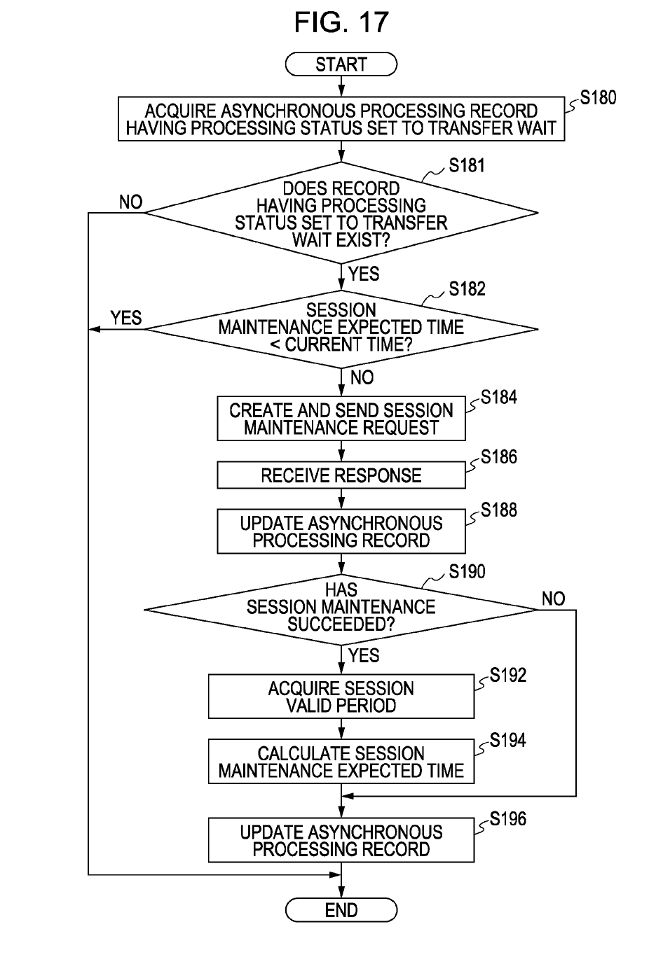

Referring to FIG. 17, an example of a flow of a session maintaining processing performed by the connection maintaining unit 228 will be described next. The connection maintaining unit 228 repeatedly performs the session maintaining processing shown in FIG. 17 at regular intervals (e.g., 20 minutes, an interval shorter than a general session timeout period of 30 minutes). The session maintaining processing starts at STEP 180. The connection maintaining unit 228 extracts a record having a value of the processing status field 584 set to “request transfer wait” from the management table (see FIG. 8). The connection maintaining unit 228 then determines whether or not the value of the session maintenance expected time field 576 of the extracted record indicates a time before the current time (STEP 182). If the record having the value set to “request transfer wait” does not exist in the management table (NO of STEP 181) or if the current time exceeds the value of the session maintenance expected time field 576 (YES of STEP 182), the connection maintaining unit 228 terminates the processing.

On the other hand, if the record having the value set to “request transfer wait” exits and the value of the session maintenance expected time field 576 indicates the future time, the connection maintaining unit 228 creates a session maintenance request using the authentication cookie information of the client 100a registered at the authentication information field 574 of the extracted record. The connection maintaining unit 228 then sends the session maintenance request to a URL for session maintenance registered in the corresponding record of the application table (see FIG. 7(a)) (STEP 184). Upon receiving a response to the session maintenance request (STEP 186), the session maintaining unit 228 updates the session maintenance result field 578 of the record in the management table using the result of the session maintenance request (STEP 188).

The connection maintaining unit 228 determines whether or not the result of the session maintaining request is a success next (STEP 190). If the result indicates the success (YES of STEP 190), the connection maintaining unit 228 acquires the session valid period from the corresponding record of the application table (see FIG. 7(a)) (STEP 192), and adds the session valid period to the current time to calculates a new session maintenance expected time (STEP 194). Lastly, the connection maintaining unit 228 updates the session maintenance expected time field 576 of the record of the management table using the determined session maintenance expected time (STEP 196). If the result of the session maintenance request is determined to be a failure at STEP 190 (NO of STEP 190), the connection maintaining unit 228 changes the session maintenance expected time field 576 of the record of the management table to “to be determined”. After performing STEP 196, the connection maintaining unit 228 terminates the processing.

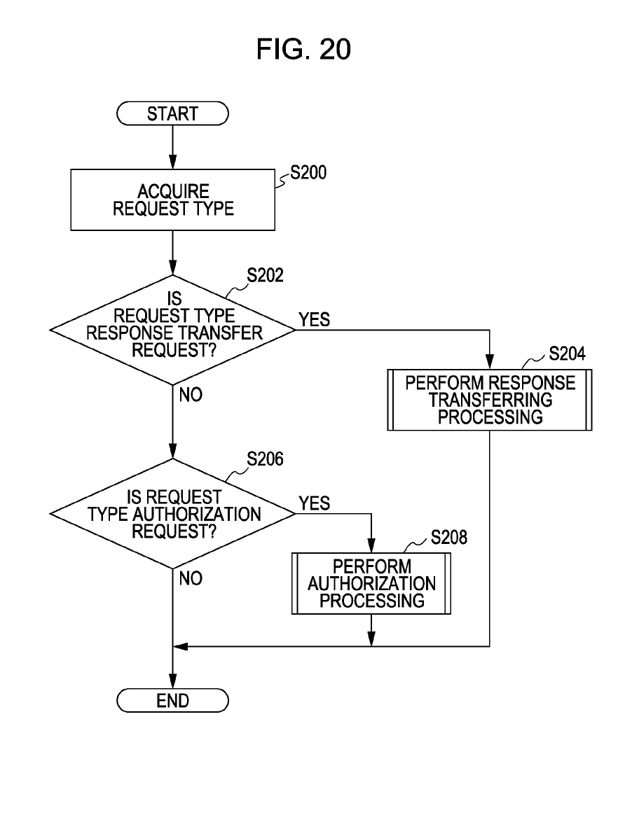

An example of a detailed processing flow of the local processing shown at STEP 116 of FIG. 13 will be described next with reference to FIG. 20. FIG. 20 shows a more detailed communication data sorting processing performed by the first determining unit 206. The processing starts at STEP 200, and the first determining unit 206 acquires a URI specified in a request message included in a data section of the communication data to acquire a type of the request. For example, as is clear from a response providing URL of a dummy response message shown in FIG. 10 and a result providing URL of an authorization request shown in FIG. 11, the type of the access request can be identified by the URI.

If the type of the request is the response transfer request of the client 100a (YES of STEP 202), the first determining unit 206 supplies the communication data to the dummy message responding unit 218 and the transferring unit 230 to cause the dummy message responding unit 218 and the transferring unit 230 to perform the response transfer processing (STEP 204). If the type of the request is the authentication report of the client 100b (YES of STEP 206), the first determining unit 206 supplies the communication data to the authorization processing unit 224 to cause the authorization processing unit 224 to perform the authorization processing (S208). Thereafter, the processing is terminated.

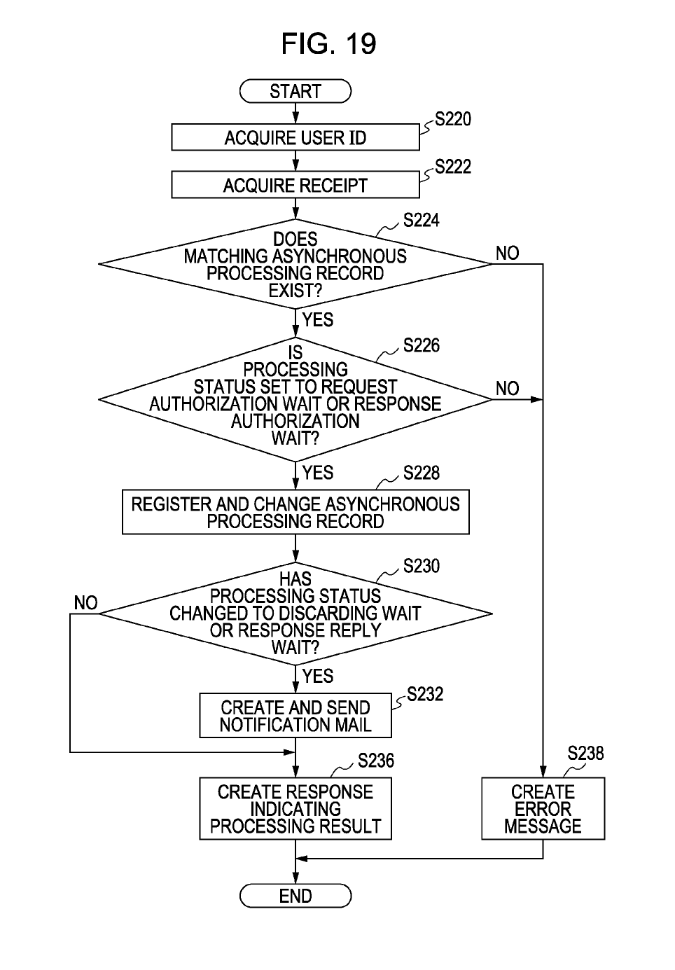

FIG. 19 shows an example of a detailed processing flow of the authorization processing performed by the authorization processing unit 224. The authorization processing unit 224 extracts a user ID and a receipt form an authorization report of the client 100b (STEPs 220 and 222). The authorization processing unit 224 then determines whether or not a matching record exists in the management table (STEP 224). If the matching record exists (YES of STEP 224), the authorization processing unit 224 further determines whether or not the value of the processing status field 584 of the corresponding record is “request authorization wait” or “response authorization wait” (STEP 226). In the case of YES at STEP 226, the authorization processing unit 224 changes the value of the processing status field 584 to “request transfer wait”, “request reply wait”, or “discarding wait”. The authorization processing unit 224 also registers the authorization result included in the authorization report at the authorization result field 588 of the record (STEP 228).

In addition, the authorization processing unit 224 determines whether or not the above-described change of the value of the processing status field 584 is a change to discarding wait or response reply wait (STEP 230). If the above-described change is the change to discarding wait or the response reply wait (YES of STEP 230), the authorization processing unit 224 creates a notification mail for notifying a user of the client 100a of the authorization result, and sends the notification mail to the client 100a (STEP 232). After performing STEP 232 or in the case of NO at STEP 230, i.e., if the above-described change is the change to request transfer wait, the process proceeds to STEP 236. At STEP 236, the authorization processing unit 224 creates a response indicating the authorization processing result as a response to the authorization report of the client 100b. On the other hand, in the case of NO at STEP 224 or 226, the process proceeds to STEP 238. At STEP 238, the authorization processing unit 224 creates an error message as a response to the authorization report of the client 100b. Thereafter, the authorization processing unit 224 terminates the processing.

FIG. 18 shows an example of a more detailed processing flow of the response transfer processing performed by the dummy message responding unit 218 and the transferring unit 230. The dummy message responding unit 218 extracts a user ID and a receipt from the response transfer request of the client 100a (STEPs 240 and 242), and determines whether or not a matching record exists in the management table (STEP 244). If the matching record does not exist (NO of STEP 244), the dummy message responding unit 218 supplies the result indicating the response transfer request has “failed” to the transferring unit 230. The transferring unit 230 creates an error message as a response to the response transfer request of the client 100a (STEP 248).

If the matching record exists (YES of STEP 244), the dummy message responding unit 218 determines whether or not the value of the processing status field 584 of the corresponding record is “response reply wait” (STEP 246). In the case of YES at STEP 246, the dummy message responding unit 218 supplies a result indicating that the response transfer request has “succeeded” to the transferring unit 230. The transferring unit 230 acquires the response of the web server 300 from the record (STEP 250), and further changes the value of the processing status field 584 to “discarding wait” (STEP 252). On the other hand, if the value of the processing status field 584 of the record is not “response reply wait” (NO of STEP 246), the dummy message responding unit 218 supplies a result indicating that the processing state of the response transfer request is “response reception wait” to the transferring unit 230. The transferring unit 230 creates a response indicating the current processing status as a response to the response transfer request of the client 100a (STEP 254). The transferring unit 230 then terminates the processing.

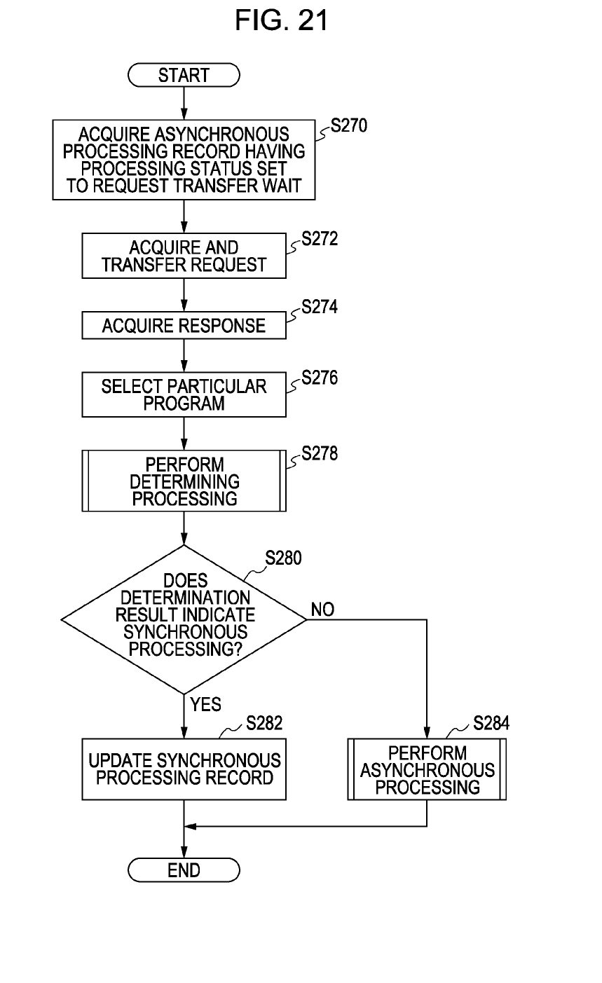

FIG. 21 shows an example of a flow of the transfer processing of a request of the client 100a performed by the transferring unit 230. The transferring unit 230 repeatedly performs the request transfer processing shown in FIG. 21 at regular intervals (for example, 5 minutes). The interval may be determined in consideration of a balance between a load of the proxy server 200a and a response speed of a response to an access request of the client. The request transfer processing starts at STEP 270, and the transferring unit 230 extracts a record having a value of the processing status field 584 set to “request transfer wait” from the management table (see FIG. 8). The transferring unit 230 then transfers the request included in the extracted record to the web server 300 (STEP 272). The web server 300 processes the access request, and returns a response.

Upon the proxy server 200a receiving the response to the access request, the response is supplied to the second determining unit 208 through the processing shown in FIGS. 12 and 13 described above (STEP 274). The second determining unit 208 selects the determining program for the response on the basis of the corresponding access request (STEP 276). The selected determining program performs the determination processing on the response (STEP 278). The second determining unit 208 determines whether or not the determination result of the determining program is “synchronous processing” (STEP 280). The second determining unit 208 then supplies the response and the determination result to the asynchronous processing section 216 regardless of the determination result.

If the determination results indicate “synchronous processing” and “permission”, the asynchronous processing section 216 changes the value of the authorization result field 588 of the management table to “response permitted”, and further changes the processing status field 584 of the management table to “response reply wait”. If the determination results indicate “synchronous processing” and “rejection”, the asynchronous processing 216 changes the value of the authorization result field 588 of the management table to “response rejected”, and further changes the processing status field 584 of the management table to “discarding wait” (STEP 282).

On the other hand, the determination result indicates “asynchronous processing”, the asynchronous processing section 216 performs the asynchronous processing described above with reference to FIG. 16 (STEP 284). The asynchronous processing section 216 then terminates the processing.

As described above, according to one embodiment, if the proxy server 200a determines that the amount of time to process an access request submitted by the client 100a will meet or exceed some threshold time period, the proxy server 200a sends a dummy response message to the client 100a for notifying the client 100a that a response of the web server 300 will be separately sent to the client 100a as a response to the access request. Accordingly, the proxy server 200a can request an authorizer to authorize transfer of an access request or a response to the access request without being concerned about a delay in the transfer of a response of the web server 300 to an access request of the client 100a, which allows flexible access control to be performed.

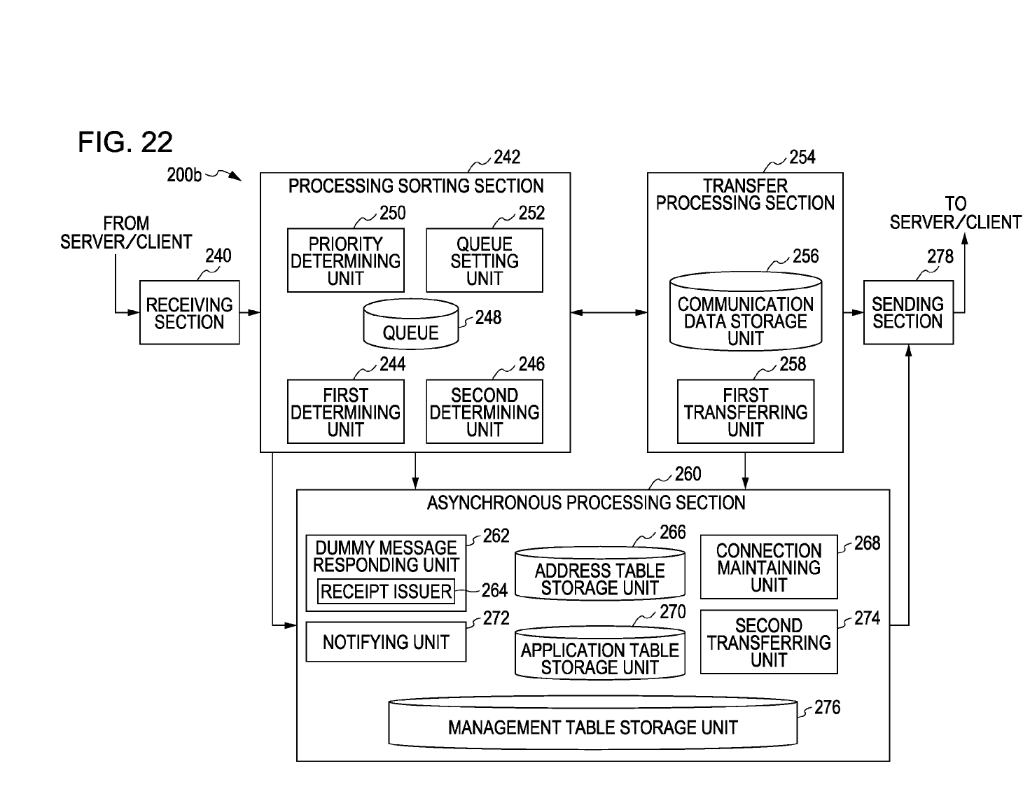

FIG. 22 shows a functional configuration of a proxy server 200b according to another embodiment of the present invention. In this embodiment, in response to, for example, a user's operation, a program used for relaying communication stored on a hard disk of an HDD 430 is loaded to a RAM 410 by an operation of an operating system. The operating system gives instructions to a CPU 400 and other peripheral devices by the program invoking predetermined API routines of the operating system, thereby allowing the proxy server 200b to function as a receiving section 240, a processing sorting section 242, a transfer processing section 254, an asynchronous processing section 260, and a sending section 278. Hereinafter, configurations and functions different from those according to the embodiment described earlier herein will be mainly described.

The receiving section 240 has functions similar to those of the receiving section 202 according to the earlier embodiment described herein. However, communication data received by the receiving section 240 according to this embodiment does not include an authorization result supplied from a client 100b serving as an authorizer. The processing sorting section 242 has a function to sort the communication data received by the receiving section 240 to one of the processing sections. The processing sorting section 242 includes a queue 248, a priority determining unit 250, and a queue setting unit 252 in addition to a first determining unit 244 and a second determining unit 246. Since the first determining unit 244 has the same function as that of the first determining unit 206 according to the embodiment described earlier herein, description thereof is omitted.

The second determining unit 246 determines whether or not the transfer of a response of the web server 300 to the access request to the client 100a will meet or exceed some threshold amount of time regarding the communication data received from the first determining unit 244. That is, the second determining unit 246 determines whether or not a dummy response message has to be created and asynchronous processing has to be performed so that the client 100a can terminate communication. In this embodiment, the proxy server 200b also manages and processes the access request of the client 100a in association with the response of the web server 300 to the access request. The second determining unit 246 performs determination processing on the access request of the client 100a. The response of the web server 300 is processed according to the result of the determination performed on the corresponding access request. When the communication data is an access request of the client 100a, the second determining unit 246 according to this embodiment supplies the access request to the priority determining unit 250, which will be described later. The queue 248 and the queue setting unit 252 that are related to processing performed by the priority determining unit 250, and the priority determining unit 250 will be described first.

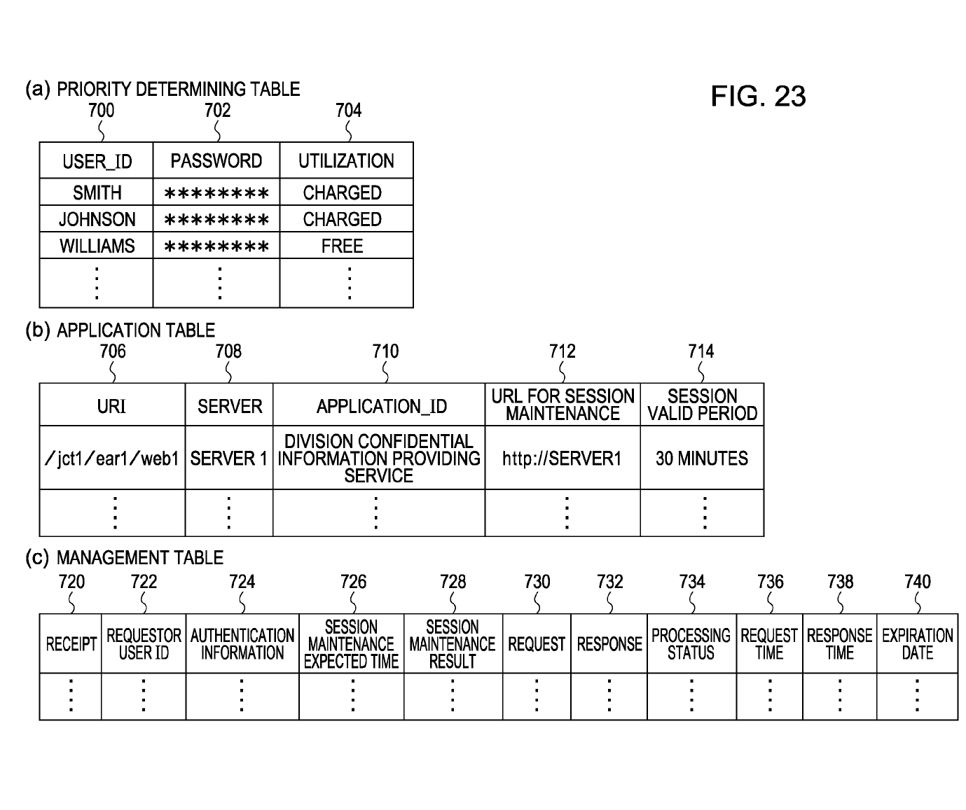

The queue 248 stores a request for performing transfer processing of the access request that is received by the receiving section 240. The priority determining unit 250 determines a priority of the transfer processing of the access request of the client 100a on the basis of a categorization of a user of the client 100a. Here, the categorization of the user includes a categorization by an attribute of users of the clients 100a, such as, for example, charged users who are registered and pay money to receive services provided by the web server and non-charged users who are not registered and receive services free, and a categorization by an attribute of clients 100a, such as small mobile information terminals, e.g., mobile phones and PDAs (Personal Digital Assistance), having a limited processing capability and information processing terminals, e.g., personal computers and workstations, having a high processing capability. The priority determining unit 250 gives a higher priority to the charged users or small mobile information terminals having the limited processing capability. The priority determining unit 250 prestores such attribute information of users and clients 100a in association with user IDs and passwords therein (see FIG. 23(a)).

The queue setting unit 252 stores the request for performing transfer processing of the access request of the client 100a at an appropriate position in the queue 248 on the basis of the priority determined by the priority determining unit 250. More specifically, the queue setting unit 252 stores the request for performing transfer processing of the access request having a higher priority at a position so that the request is pulled out before pulling out the transfer processing, already stored in the queue 248, having a lower priority. After supplying the access request to the priority determining unit 250, the second determining unit 246 determines whether or not the number of access requests to be transferred to the web server 300 earlier than the determination-target access request is equal to or greater than a predetermined value on the basis of information stored in the queue 248. If the number of the access requests to be transferred to the web server 300 earlier is equal to or grater than the predetermined value, the second determining unit 246 determines that the transfer of the response of the web server 300 to the access request to the client 100a will be greater than or equal to a threshold time period, and supplies the access request to both of the transfer processing section 254 and the asynchronous processing section 260.

On the other hand, if the number of the access requests to be transferred to the web server 300 earlier is smaller than the predetermined value, the second determining unit 246 supplies the access request to the transfer processing section 254, which will be described later. As described above, if the communication data is a response of the web server 300, the second determining unit 246 supplies the response to either the transfer processing section 254 or the asynchronous processing section 260 to perform processing according to the determination obtained regarding the corresponding access request. More specifically, if it is determined that the asynchronous processing has to be performed on the access request, the corresponding response is supplied only to the asynchronous processing section 260. If it is determined that asynchronous processing does not have to be performed on the access request, the corresponding response is supplied only to the transfer processing section 254.

The transfer processing section 254 has a function to transfer communication data to the web server 300. The transfer processing section 254 includes a communication data storage unit 256 and a first transferring unit 258. The communication data storage unit 256 stores communication data received from the second determining unit 246. The first transferring unit 258 sequentially pulls out request for the transfer processing from the queue 248, reads out the communication data corresponding to the request for transfer processing from the communication data storage unit 256, and transfers the communication data to the web server 300 or the client 100a through the sending section 278.

The asynchronous processing section 260 has a function for processing communication data regarding which the transfer of a response of the web server 300 to the access request to the client 100a is determined to take an amount of time equal to or longer than a threshold time period. The asynchronous processing section 260 includes a dummy message responding unit 262, an address table storage unit 266, a connection maintaining unit 268, an application table storage unit 270, a notifying unit 272, a second transferring unit 274, and a management table storage unit 276. The asynchronous processing section 260 according to this embodiment generally has the same configurations and functions as the asynchronous processing section 216 according to the embodiment described earlier herein. However, the asynchronous processing section 260 according to this embodiment includes the notifying unit 272 instead of the authorization processing unit 224.

The application table storage unit 270 stores attribute information regarding web applications executed by the web server 300 to provide services to the clients 100. FIG. 23(b) shows an example of an application table. The application table used in this embodiment corresponds to the application table used in the embodiment described earlier herein that additionally includes a URI field 706 and a server field 708. The added fields store a URI indicating a target of the access request that can be specified in the access request and a server ID of a server having the URI. In addition, an application_ID field 710 stores an ID of a web application executed in the web server 300 related to the URI stored at the URI field 706. Since a session maintenance URL field 712 and a session valid period field 714 are the same as those of the application table used in the embodiment described earlier herein, which has been described with reference to FIG. 7(a), the description thereof is omitted.

Since the address table storage unit 266 is the same as the address table storage unit 222 in the embodiment described earlier herein, the description thereof is omitted. The management table storage unit 276 stores a management table used for managing processing performed on the communication data, received from the second determining unit 246, by each unit of the asynchronous processing section 260. FIG. 23(c) shows an example of a management table stored in the management table storage unit 276. As is clear from FIG. 23(c), the management table according to this embodiment corresponds to the management table according to the embodiment described earlier herein from which some fields are removed, and is generally the same as the management table according to the embodiment described earlier herein. Accordingly, the description of each field is omitted.

Upon receiving the access request from the second determining unit 246, the asynchronous processing section 260 creates a blank record for the communication data in the management table. The asynchronous processing section 260 then registers the user ID extracted from the access request at a requester user ID field 722. The asynchronous processing section 260 also registers the access request, “request transfer wait”, and a time at which the receiving section 240 has received the communication data at a request field 730, a processing status field 734, and a request time field 734, respectively. In addition, when access request is transferred, the first transferring unit 258 of the transfer processing section 254 notifies the asynchronous processing section 260 of completion of the transfer. The notified asynchronous processing section 260 retrieves a corresponding record from the management table, and changes a value of the processing status field 734 of the record to “response reception wait”.

On the other hand, when the asynchronous processing section 260 receives the response of the web server 300 from the second determining unit 246, the record corresponding to the response has been already registered in the management table. Thus, the asynchronous processing section 260 registers the response of the web server 300 or a pointer to the response of the web server 300, “response reply wait”, and a time at which the receiving section 240 has received the communication data at a response field 732, the processing status field 734, and a response time field 738, respectively.

The value registered at the processing status field 734 indicates a state of processing of the communication data in the asynchronous processing section 260. The status transition of the processing status of the communication data according to this embodiment corresponds to the state transition diagram shown in FIG. 9 excluding a state of “request authorization wait” and a state of “response authorization wait”.

When the communication data is an access request of the client 100a, the asynchronous processing section 260, as in the case of the asynchronous processing section 216 according to the embodiment described earlier herein, further registers authentication cookie information previously created for the client 100a by the web server 300 at an authentication information field 724 of the record of the management table. In addition, the asynchronous processing section 260 further registers, at a session maintenance expected time field 726, a time obtained by adding a session valid period (see FIG. 23(b)) at the corresponding record of the application table to the value of the request time field 736 of the record. Other fields of the management table will be described in the description of each processing unit of the asynchronous processing section 260.

Since the dummy message responding unit 262 and a receipt issuer 264 have the same functions as the dummy message responding unit 218 and the receipt issuer 220 according to the embodiment described earlier herein, the description thereof is omitted. The receipt issuer 264 according to this embodiment also registers an issued receipt and a valid period of the receipt at a receipt field 720 and an expiration date field 740 of the corresponding record of the management table. In addition, a dummy response message is created by the dummy message responding unit 262 according to this embodiment by simply appropriately changing the first sentence in the example dummy response message shown in FIG. 10. For example, the first sentence may be change to a sentence of “It is determined that the browser that user are using cannot receive a result because it takes a time to complete processing of the following request.”

The notifying unit 272 checks the management table at regular intervals to detect a record having a value of the processing status field 734 set to “response reply wait”. Upon detecting such a record, the notifying unit 272 notifies the client 100a that the response of the web server 300 is transferable. For example, an email can be utilized as the notifying method. An email address of the notification destination can be obtained by retrieving a matching record from the address table stored in the address table storage unit 266 using the requester user ID read out from the management table as a retrieval key.

The connection maintaining unit 268 regularly sends dummy communication data to the web server 300 in order to enable the web server 300 to maintain the session with the client 100a until the access request of the client 100a is transferred to the web server 300. The sending destination of the dummy communication data is obtained by reading out a URL for session maintenance of the matching record from the application table (see FIG. 23(b)) using the web application ID as a retrieval key. In addition, the dummy communication data sent to the web server 300 uses authentication cookie information registered at the authentication information field 724 of the management table. Since a specific sending method of the dummy communication data sent by the connection maintenance unit 268 using the management table is the same as that described in the embodiment described earlier herein, the description thereof is omitted.

The second transferring unit 274 transfers the response of the web server 300 to the client 100a in response to receiving a transfer request from the client 100a, which is transmitted by the client 100a in response to the client 100a being notified that the response of the web server 300 is available for transfer to the client 100a. In some embodiments, the second transferring unit 274 transfers the response of the web server 300 to the client 100a under the condition that the receipt is received from the client 100a in response to the transfer request from the notified client 100a. Since the verification of the receipt performed by the dummy message responding unit 262 and the transfer processing performed by the second transferring unit 274 based on the verification result of the dummy message responding unit 262 are the same as those performed by the dummy message responding unit 218 and the transferring unit 230 according to the embodiment described earlier herein, the description thereof is omitted.

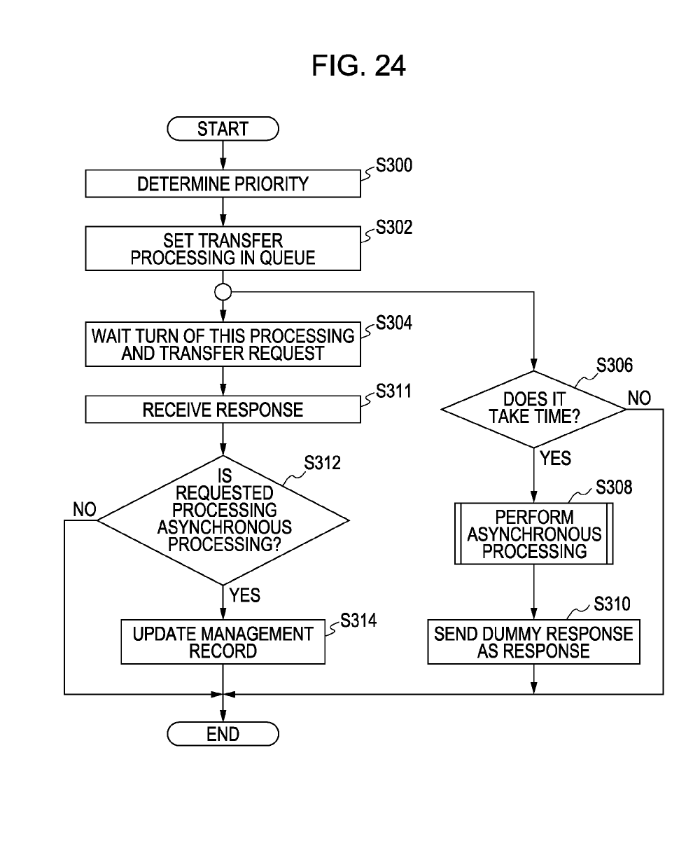

An example of a processing flow of processing for relaying data communication performed by the proxy server 200b according to this embodiment will be described with reference to FIG. 24. The processing for relaying performed by the proxy server 200b according to this embodiment is generally the same as the access control processing of the proxy server 200a according to the embodiment described with reference to FIG. 14 excluding the transfer processing performed after the processing sorting, which is performed by the first determining unit 206. Thus, only the transfer processing performed by the proxy server 200b will be described here. The determination processing performed by the determining program described with reference to FIG. 15, the authorization processing described with reference to FIG. 19, and the access request transfer processing described with reference to FIG. 21 are not included in the access control processing performed by the proxy server 200b according to this embodiment.

The transfer processing performed after the sorting processing by the first determining unit 244 starts at STEP 300. The priority determining unit 250 determines a priority of the request for transfer processing of the access request of the client 100a received by the receiving section 240 on the basis of a categorization of a user of the client 100a. The queue setting unit 252 stores the request for the transfer processing of the access request of the client 100a at an appropriate position in the queue 248 on the basis of the priority determined by the priority determining unit 250 (STEP 302). Thereafter, the access request is stored in the communication data storage unit 256 of the transfer processing section 254.

When the transferring processing to be processed earlier than the transfer processing of the access request no longer exists in the queue 248, the first transferring unit 258 then reads out the access request corresponding to the request for transfer processing of the access request from the communication data storage unit 256, and transfers the access request to the corresponding web server 300 (STEP 304). In parallel to the above-described processing at STEP 304, the second determining unit 246 determines whether or not the number of the access requests to be transferred to the web server 300 earlier than the target access request is equal to or greater than a predetermined value on the basis of information stored in the queue 248 (STEP 306). If the number of the access requests to be transferred to the web server 300 earlier is equal to or greater than the predetermined value, the second determining unit 246 determines that the transfer of the response of the web server 300 to the access request to the client 100a takes an amount of time equal to or longer than a threshold time period (YES of STEP 306), and supplies the access request to the asynchronous processing section 260 (STEP 308).

Since asynchronous processing performed by the asynchronous processing section 260 is generally the same as that described with reference to FIG. 16, the description thereof is not given here. However, creation and sending of the authorization request performed at STEP 176 of FIG. 16 are not included in the asynchronous processing according to this embodiment. The dummy response message created in the asynchronous processing is sent to the client 100a as a response to the access request (STEP 310). If it is determined that it does not take longer than the threshold time period at STEP 306 (NO of STEP 306) or after performing STEP 310, the processing is terminated. STEPs 306 to 310 are executed by a thread other than a tread that executes STEP 304. The other thread terminates the processing after executing STEP 306 or 310.

On the other hand, upon the receiving section 240 receiving a response to the transferred access request (STEP 310), the response is supplied to the second determining unit 246 through the first determining unit 244. The second determining unit 246 determines whether or not the processing performed on the access request corresponding to the response is asynchronous processing (STEP 312). If the asynchronous processing has been performed on the corresponding access request (YES of STEP 312), the second determining unit 246 supplies the response to the asynchronous processing unit 260. The asynchronous processing unit 260 retrieves the corresponding record from the management table, and updates the record (STEP 314). If the asynchronous processing has not been performed on the corresponding access request (NO of STEP 312) or after performing STEP 314, the processing is terminated.

The proxy server 200b according to this embodiment determines whether or not the number of the access requests to be transferred to the web server 300 earlier than the determination-target access request is equal to or greater than a predetermined value on the basis of the information stored in the queue 248 to determine whether or not the transfer of the response of the web server 300 to the access request of the client 100a to the client 100a takes an amount of time equal to or longer than a threshold time period. As a modification of this embodiment, the proxy server 200b may determine whether or not the response of the web server 300 can be received within some threshold time period from the transmission of the access request of the client 100a to the web server 300 to determine whether or not the transfer of the response of the web server 300 to the client 100a takes an amount of time equal to or longer than a threshold time period.

In this modification, the processing sorting section 242 shown in FIG. 22 does not have to include the queue 248, the priority determining unit 250, and the queue setting unit 252. If the communication data received from the first determining unit 244 is an access request of the client 100a, the second determining unit 246 supplies the communication data to the first transferring unit 258 to cause the first transferring unit 258 to transfer the communication data to the web server 300 through the sending section 278. If the second determining unit 246 does not receive the response of the corresponding web server 300 within a certain period of time from the transfer of the access request, the second determining unit 246 supplies the access request and a determination result of “asynchronous processing” to the asynchronous processing unit 260 in order to create a new record in the management table. If the communication data received from the first determining unit 244 is a response from the web server 300, the second determining unit 246 supplies the response to the asynchronous processing unit 260 or the transfer processing section 254 according to the determination result for the corresponding access request.

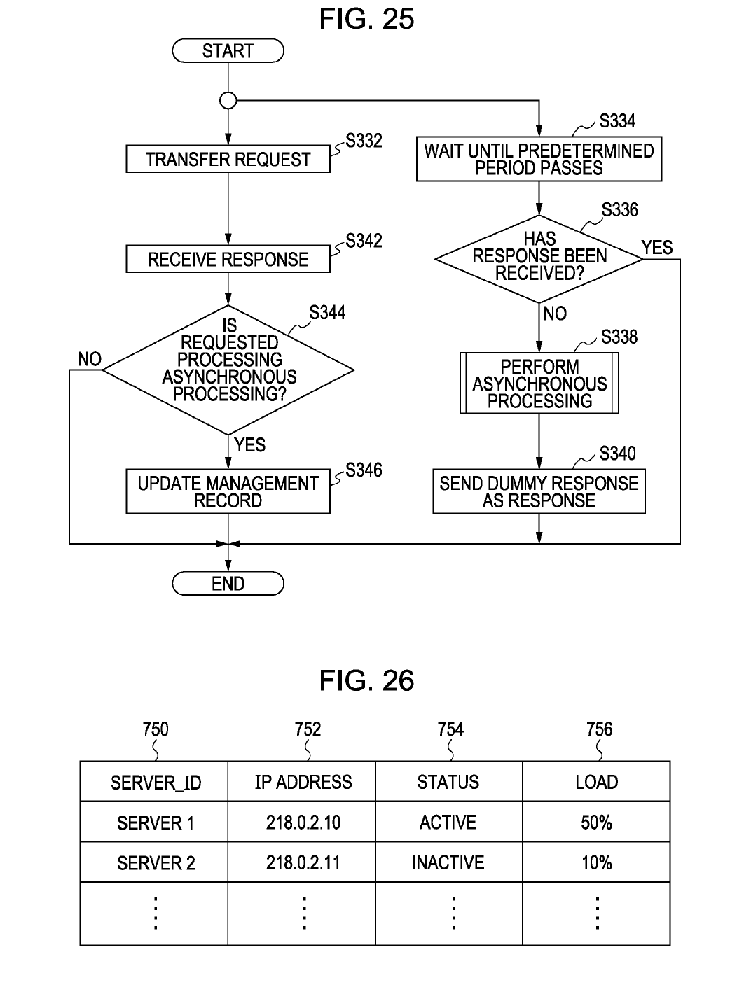

An example of a flow of transfer processing according to the modification of this embodiment will be described with reference to FIG. 25. The transfer processing starts at STEP 332 after the sorting processing is performed by the first determining unit 244. The second determining unit 246 supplies the first transferring unit 258 with the access request of the client 100a received by the receiving section 240. The first transferring unit 258 transfers the access request to the web server 300. In parallel to STEP 332, the second determining unit 246 waits for a predetermined period after the transfer of the access request (STEP 334). After the predetermined period, the second determining unit 246 determines whether or not the receiving section 240 has received the response of the web server 300 to the access request (STEP 336).

If the response of the web server 300 cannot be obtained within the predetermined period (NO of STEP 336), the second determining unit 246 determines that the transfer of the response of the web server 300 to the access request to the client 100a takes an amount of time equal to or longer than the predetermined period. The second determining unit 246 supplies the access request and a determination result of “asynchronous processing” to the asynchronous processing section 260 to cause the asynchronous processing section 260 to perform asynchronous processing (STEP 338). Since the asynchronous processing performed by the asynchronous processing section 260 is generally the same as that described with reference to FIG. 16, the description is not given herein. However, creation and sending of the authorization request performed at STEP 176 of FIG. 16 are not included in the asynchronous processing shown at STEP 338.

Thereafter, the dummy response message created in the asynchronous processing is sent to the client 100a from the dummy message responding unit 262 through the sending section 278 as a response to the access request (STEP 340). If the response of the web server 300 can be received within the predetermined period (YES of STEP 336) or after performing STEP 340, the processing is terminated. STEPs 334 to 340 are executed by a thread other than a tread that executes STEP 332. The other thread terminates the processing after executing STEP 336 or 340.

On the other hand, if the receiving section 240 receives a response of the web server 300 to the transferred access request, the received response is supplied to the second determining unit 246 through the first determining unit 244 (STEP 342). The second determining unit 246 determines whether or not the processing performed on the access request corresponding to the response is asynchronous processing (STEP 344). If the asynchronous processing is performed on the corresponding access request (YES of STEP 344), the second determining unit 246 supplies the response to the asynchronous processing unit 260. The asynchronous processing section 260 retrieves the corresponding record from the management table, and updates the record (STEP 346). If the asynchronous processing is not performed on the corresponding access request (NO of STEP 344) or after performing STEP 346, the processing is terminated.

As a further modification of the above-described embodiment, the proxy server 200b may determine whether or not the transfer of a response of the web server 300 to the client 100a takes an amount of time equal to or longer than a threshold time period on the basis of a current processing load of the web server 300. In this further modification, the processing sorting section 242 shown in FIG. 22 has a server table shown in, for example, FIG. 26 instead of the queue 248, the priority determining unit 250, and the queue setting unit 252. A server_ID field 750 stores a server name of the web server 300. An IP address field 752 stores an IP address of the web server 300. A status field 754 stores an operation state (i.e., active or inactive) of the web server 300. A load field 756 stores a load of the web server 300. The proxy server 200b regularly receives, from the web server 300, a notification regarding the operation state and the load of the web server 300.

In this further modification, if the communication data received from the first determining unit 244 is an access request of the client 100a, the second determining unit 246 supplies the access request to the first transferring unit 258 to cause the first transferring unit 258 to transfer the access request to the web server 300 through the sending section 278. In parallel to this processing, the second determining unit 246 retrieves a matching record from the server table using an IP address of a sending destination included in the access request or a server name corresponding to a requested URI in an HTTP message included in a data section as a retrieval key, and checks the load of the web server 300. If the load of the web server 300 is high, the second determining unit 246 supplies the access request and a determination result of “asynchronous processing” to the asynchronous processing section 260 to create a new record in the management table. If the communication data received from the first determining unit 244 is a response of the web server 300, the second determining unit 246 supplies the response to the asynchronous processing section 260 or the transfer processing section 254 according to the determination result for the corresponding access request.

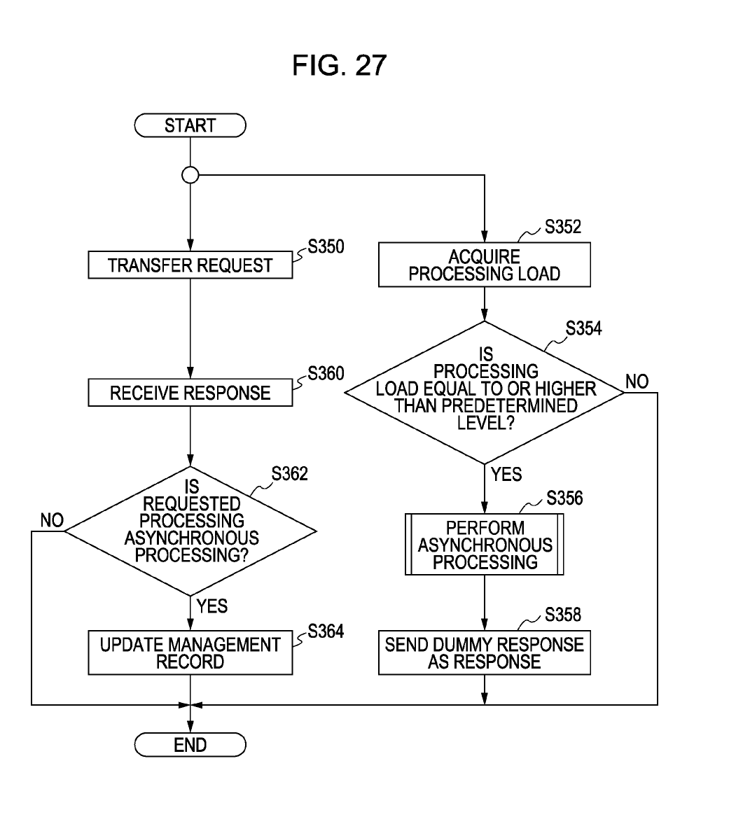

An example of a flow of transfer processing according to this further modification of the embodiment will be described with reference to FIG. 27. The transfer processing starts at STEP 350 after the sorting processing is performed by the first determining unit 244. The second determining unit 246 supplies the first transferring unit 258 with the access request of the client 100a received by the receiving section 240. The first transferring unit 258 transfers the access request to the web server 300. In parallel to STEP 350, the second determining unit 246 reads out the corresponding record from the server table to acquire the load information of the web serve 300 (STEP 352).

If the load equal to or higher than a predetermined level is imposed on the web server 300 (YES of STEP 354), the second determining unit 246 determines that the transfer of the response of the web server 300 to the access request to the client 100a takes an amount of time equal to or longer than a threshold time period. The second determining unit 246 then supplies the access request and a determination result of “asynchronous processing” to the asynchronous processing section 260 to cause the asynchronous processing section 260 to perform asynchronous processing (STEP 356). Since the asynchronous processing performed by the asynchronous processing section 260 is generally the same as that described with reference to FIG. 16, the description thereof is not given here. However, creation and sending of the authorization request performed at STEP 176 of FIG. 16 are not included in the asynchronous processing shown at STEP 356.

Thereafter, the dummy response message created in the asynchronous processing is sent to the client 100a from the dummy message responding unit 262 through the sending section 278 as a response to the access request (STEP 358). If the load imposed on the web server 300 is lower than the predetermined level (NO of STEP 354) or after performing STEP 358, the processing is terminated. STEPs 352 to 358 are executed by a thread other than a tread that executes STEP 350. The other thread terminates the processing after executing STEP 354 or 358.

On the other hand, if the receiving section 240 receives a response of the web server 300 to the transferred access request, the received response is supplied to the second determining unit 246 through the first determining unit 244 (STEP 360). The second determining unit 246 determines whether or not the processing performed on the access request corresponding to the response is asynchronous processing (STEP 362). If the asynchronous processing is performed on the corresponding access request (YES of STEP 362), the second determining unit 246 supplies the response to the asynchronous processing section 260. The asynchronous processing section 260 retrieves the corresponding record from the management table, and updates the record (STEP 364). If the asynchronous processing is not performed on the corresponding access request (NO of STEP 362) or after performing STEP 364, the processing is terminated.

As described above, when it is determined that reception of a response to the access request from the web server 300 takes an amount of time equal to or longer than a threshold time period because the load of the web server 300 is high, the proxy server 200b according to this embodiment sends a dummy response message for notifying the client that the response of the web server 300 will be separately sent to the client as a response to the access request. Accordingly, a delay in transfer of a response of the web server 300 to an access request of the client 100a does not have to be considered, which allows the proxy server 200b to perform additional operations for processing communication data in an order different from the reception order, such as preferentially processing an access request from charged users who are registered and pay money to receive services provided by the web server 300 and small mobile information terminal having a limited processing capability.

Although the present invention has been described using embodiments above, the technical scope of the present invention is not limited by the above-described embodiments. It is obvious for those skilled in the art that various modifications and improvements can be added to the above-described embodiments. Accordingly, such modifications and improvements should be included in the technical scope of the present invention.

What is claimed is:

1. A proxy device for relaying data communication between a client and a server, comprising:
a receiving unit for receiving an access request directed to the server from the client;
a policy storage unit for storing a policy that defines a criterion for identifying communication data whose transfer to a destination needs to be authorized by an authorizer;
a determining unit for determining whether the transfer of the access request or a response of the server to the access request needs to be authorized by the authorizer on the basis of the policy and for determining whether the transfer of the response of the server to the client will take an amount of time equal to or longer than a threshold time period;
a dummy message responding unit for sending, in response to a determination result indicating that the transfer of the response to the client will take an amount of time equal to or longer than the threshold time period, a dummy response message to the client for notifying the client that the response of the server will be sent to the client when the response becomes available for transfer; and
a transferring unit for transferring, upon the response of the server becoming transferable to the client, the response to the client.

2. The proxy device according to claim 1, wherein the access request includes request sender information, request receiver information, and a content of the request, and wherein the policy defines a criterion, regarding at least one of the request sender information, the request receiver information, and the content of the request, for identifying the communication data whose transfer needs to be authorized by the authorizer.

3. The proxy device according to claim 2, wherein the transferring unit transfers the access request to the server under the condition that the transfer of the access request to the server is authorized by the authorizer.

4. The proxy device according to claim 1, wherein the response from the server includes response sender information, response receiver information, and a content of the response, and wherein the policy defines a criterion, regarding at least one of the response sender information, the response receiver information, and the content of the response, for identifying the communication data whose transfer needs to be authorized by the authorizer.

5. The proxy device according to claim 4, wherein the transferring unit transfers the response of the server to the client under the condition that the transfer of the response of the server to the client is authorized by the authorizer.

6. The proxy device according to claim 1, further comprising an authorization processing unit for sending, in response to a determination result indicating that authorization is needed, an authorization request to an authorization request receiver, wherein the policy storage unit stores, for each access request receiver that can be set in the access request of the client, the policy to be applied in association with the authorization request receiver for authorizing the communication data that is determined to require authorization on the basis of the policy.

7. The proxy device according to claim 6, further comprising a management table storage unit for storing a processing status and a processing result of the authorization processing performed by the authorization processing unit, wherein the authorization processing unit notifies, in response to an end of the authorization processing, the client of the processing result.

8. The proxy device according to claim 7, wherein the transferring unit transfers the response of the server to the client under the condition that the proxy device receives a transfer request from the client that was notified of a success result.

9. The proxy device according to claim 8, wherein the dummy message responding unit includes a receipt issuer for issuing a receipt that is included in the dummy response message and that indicates a valid receiver of the response, and wherein the transferring unit transfers the response to the client under the condition of further receiving the receipt from the client that sent the transfer request to the proxy device.

10. The proxy device according to claim 1, further comprising:
an authentication information storage unit for temporarily storing authentication information used in authentication sent from the client to the server; and
a connection maintaining unit for regularly sending, to the server, the authentication information read out from the authentication information storage unit in order to enable the server to maintain the session with the client until the transfer of the access request of the client to the server is authorized by the authorizer.

11. A proxy device for relaying data communication between a client and a server, comprising:
a receiving unit for receiving an access request directed to the server from the client;
a request storage unit for temporarily storing the received access request;
a queue for storing a request for performing transferring processing of the access request;
a queue setting unit for setting, in response to the reception of the access request, the request for performing transferring processing of the access request in the queue;
a first transferring unit for sequentially pulling the request for performing transferring processing from the queue and transferring the access request to the server;
a determining unit for determining whether a number of requests to be transferred to the server before the transfer of the access request is equal to or greater than a predetermined value on the basis of information stored in the queue, the predetermined value indicating whether the transfer of a response of the server to the access request to the client will take an amount of time equal to or longer than a threshold time period;
a dummy message responding unit for sending, in response to a determination result indicating that the transfer of the response from the server will take an amount of time equal to or longer than the threshold time period, a dummy response message for notifying the client that the response of the server will be sent to the client when the response becomes available for transfer; and
a second transferring unit for transferring, upon the response of the server becoming transferable to the client, the response to the client.

12. The proxy device according to claim 11, further comprising a priority determining unit for determining a priority of the request for performing the transferring processing of the access request received from the client on the basis of a categorization of a user of the client, wherein the queue setting unit stores the request for performing the transferring processing of the access request at an appropriate position in the queue on the basis of the priority.

13. The proxy device according to claim 11, further comprising:
an authentication information storage unit for temporarily storing authentication information used in authentication sent from the client to the server; and
a connection maintaining unit for regularly sending, to the server, the authentication information read out from the authentication information storage unit in order to enable the server to maintain the session with the client while the request for performing the transferring processing of the access request is stored in the queue.

14. A method for relaying data communication executed in a proxy device for relaying data communication between a client and a server, the method comprising:
receiving an access request directed to the server from the client;
determining whether transfer of the access request or a response of the server to the access request needs to be authorized by an authorizer on the basis of a policy that defines a criterion for identifying communication data whose transfer to a destination needs to be authorized by the authorizer;
determining whether the transfer of the response of the server to the client will take an amount of time equal to or longer than a threshold time period;
sending, in response to a determination result indicating that the transfer of the response will take an amount of time equal to or longer than the threshold time period, a dummy response message for notifying the client that the response of the server will be sent to the client when the response becomes available for transfer; and
transferring, upon the response of the server becoming transferable to the client, the response to the client.

15. A method for relaying data communication executed in a proxy device for relaying data communication between a client and a server, the method comprising:
receiving an access request directed to the server from the client;
temporarily storing the received access request in a request storage unit;
setting, in response to the reception of the access request, a request for performing transferring processing of the access request in a queue;
sequentially pulling the request for performing transferring processing from the queue and transferring the access request to the server;
determining whether a number of requests to be transferred to the server before the transfer of the access request is equal to or greater than a predetermined value on the basis of information stored in the queue, the predetermined value indicating whether the transfer of a response of the server to the access request to the client will take and amount of time equal to or longer than a threshold time period;
sending, in response to a determination result indicating that the transfer of the response will take an amount of time equal to or longer than the threshold time period, a dummy response message for notifying the client that the response of the server will be sent to the client when the response becomes available for transfer; and
transferring, upon the response of the server becoming transferable to the client, the response to the client.

16. A computer program product for relaying data communication between a client and a server, the computer program product comprising:
a computer readable medium having computer usable program code embodied therewith, the computer usable program code configured to enable a proxy device to:
receive an access request directed to the server from the client;
determine whether transfer of the access request or a response of the server to the access request needs to be authorized by an authorizer on the basis of a policy that defines a criterion for identifying communication data whose transfer to a destination needs to be authorized by the authorizer;
determine whether the transfer of the response of the server to the client will take an amount of time equal to or longer than a threshold time period;
send, in response to a determination result indicating that the transfer of the response will take an amount of time equal to or longer than the threshold time period, a dummy response message for notifying the client that the response of the server will be sent to the client when the response becomes available for transfer; and
transfer, upon the response of the server becoming transferable to the client, the response to the client.
